(19) United States
(12) Patent Application Publication
(10) Pub. No.: US 2021/0274750 A1
(43) Pub. Date: Sep. 9, 2021

(54) Wearable Animal Information Apparatus, System, and Method Thereof

(71) Applicant: Hill's Pet Nutrition, Inc., Topeka, KS (US)

(72) Inventors: Susan WERNIMONT, Lawrence, KS (US); Jodi VONDRAN, Wamego, KS (US); Ryan TALLEY, Topeka, KS (US); John Michael MCCOY, JR., Topeka, KS (US); Stephen John FRENCH, Lawrence, KS (US); Cheryl STIERS, Holton, KS (US); Gerrit WASLANDER, Topeka, KS (US)

(73) Assignee: Hill's Pet Nutrition, Inc., Topeka, KS (US)

(21) Appl. No.: 15/931,876

(22) Filed: May 14, 2020

Related U.S. Application Data
(60) Provisional application No. 62/986,312, filed on Mar. 6, 2020.

(51) Int. Cl. A01K 11/00; A01K 27/00; A01K 29/00; G08B 7/06

(52) U.S. Cl. CPC A01K 11/008; A01K 27/009; G08B 7/06; A01K 29/005; A01K 27/001

(57) ABSTRACT

A wearable animal information apparatus may be provided that includes a collar configured to be worn around a portion of an animal. The collar may include an inner surface that faces the portion of the animal during use and an outer surface that faces away from the portion of the animal during use. The animal information apparatus may include a base coupled to the collar and a housing configured to couple to the base via an attachment element. The housing may include a plurality of indicators providing visual information relating to at least one of a condition of the animal or an environment surrounding the animal. An electronic device, located within the housing, may include a processor configured to receive or transmit information relating to the animal. The base may include a cavity for receiving the housing and coupling the base to the housing via the attachment element.

### CROSS-REFERENCE TO RELATED PATENT APPLICATION

The present application claims the benefit of priority from U.S. Provisional Application Ser. No. 62/986,312, filed Mar. 6, 2020, the contents of which are hereby incorporated herein by reference in its entirety.

### BACKGROUND

Pet collars are used for various reasons, such as to allow a pet to be constrained or controlled by a pet owner. As pet collars are regularly worn by a pet, identification of the pet wearing the pet collar may be provided. Such information may include the name of the pet, pet owner information, as well as other information related to the pet or pet owner. The information may be provided via non-electronic or electronic devices. Typically, however, non-electronic devices are limited in the amount of information that may be conveyed. Further, such devices are subject to degradation over time.

Electronic devices have been provided to overcome some of the deficiencies of the non-electronic tags. For example, electronic devices have been used to store information relating to a pet or a pet owner. Conventional electronic devices, however, are bulky and uncomfortable for the pet wearing the collar. Electronic devices that attach to a pet collar are difficult to attach to and/or detach from the collar worn by a pet. Thus, it is desired that a device be provided that is easy to attach to and/or detach from a pet collar, and that is less bulky and more comfortable for a pet to wear.

### BRIEF SUMMARY

The present disclosure may be directed, in one aspect, to an attachment for a wearable collar of an animal. The attachment may include an electronic device comprising a processor configured to receive or transmit information relating to the animal. An attachment body may be configured to be detachably coupled to the collar worn by the animal. The attachment body may include a cavity housing the electronic device and an opening of the cavity. The opening may provide access to the electronic device housed in the cavity or retaining the electronic device within the cavity via an enclosure element. Each of a plurality of legs may have a connection element. The connection element may be configured to engage with another connection element to detachably couple the attachment body to the collar worn by the animal.

### BRIEF DESCRIPTION OF THE DRAWINGS

The present disclosure will become more fully understood from the detailed description and the accompanying drawings, wherein:

FIG. 1A shows a perspective view of an example wearable pet collar in an open configuration, as described herein;

FIG. 1B shows a perspective view of the example wearable pet collar of FIG. 1A in a closed configuration, as described herein;

FIG. 1C shows a perspective view of another example wearable pet collar in an open configuration, as described herein;

FIG. 1D shows a perspective view of the example wearable pet collar of FIG. 1C in a closed configuration, as described herein;

FIG. 2 shows an example electronic device, as described herein;

FIG. 3 shows an example system including the electronic device of FIG. 2, as described herein;

FIGS. 4A, 4B show an example attachment having an electronic device and configured to couple with a wearable collar, as described herein;

FIGS. 5A, 5B show another example attachment having an electronic device and configured to couple with a wearable collar, as described herein;

FIGS. 6A, 6B show another example attachment having an electronic device and configured to couple with a wearable collar, as described herein;

FIGS. 7A, 7B show another example attachment having an electronic device and configured to couple with a wearable collar, as described herein;

FIGS. 8A, 8B show another example attachment having an electronic device and configured to couple with a wearable collar, as described herein;

FIGS. 9A, 9B show another example attachment having an electronic device and configured to couple with a wearable collar, as described herein;

FIGS. 10A, 10B show another example attachment having an electronic device and configured to couple with a wearable collar, as described herein;

FIGS. 11A, 11B show another example attachment having an electronic device and configured to couple with a wearable collar, as described herein;

FIGS. 12A, 12B show another example attachment having an electronic device and configured to couple with a wearable collar, as described herein;

FIGS. 13A, 13B show another example attachment having an electronic device and configured to couple with a wearable collar, as described herein;

FIGS. 14A, 14B show another example attachment having an electronic device and configured to couple with a wearable collar, as described herein;

FIGS. 15A, 15B, 15C show another example attachment having an electronic device and configured to couple with a wearable collar, as described herein;

FIG. 16 shows an example wearable collar configured to house an electronic device, as described herein;

FIGS. 17A, 17B, 17C show an example wearable collar configured to house an electronic device, as described herein;

FIGS. 18A, 18B show an example wearable collar configured to house an electronic device, as described herein;

FIGS. 19A, 19B show an example wearable collar configured to house an electronic device, as described herein;

FIGS. 20A, 20B, 20C show an example wearable collar configured to house an electronic device, as described herein;

FIG. 21 shows an example attachment having an electronic device and configured to couple with a wearable collar, as described herein;

FIG. 22 shows an example wearable collar configured to house one or more components of an electronic device, as described herein;

FIGS. 23A, 23B show an example attachment having an electronic device and configured to couple with a wearable collar, as described herein;

FIGS. 24A, 24B show an example attachment having an electronic device and configured to couple with a wearable collar, as described herein;

FIGS. 25A, 25B, 25C show another example attachment having an electronic device and configured to couple with a wearable collar, as described herein;

FIGS. 26A, 26B, 26C show another example attachment having an electronic device and configured to couple with a wearable collar, as described herein; and

FIGS. 27A, 27B, 27C show another example attachment having an electronic device and configured to couple with a wearable collar, as described herein.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present inventions. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise.

The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to an interpretation of “based entirely on.”

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Features of the present inventions may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth (e.g., Bluetooth classic, Bluetooth low energy), LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present inventions may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

Collars and other devices (e.g., harnesses) are devices used on animals, such as pets, to constrain the pet. For example, a pet may wear a collar during a walk with a pet owner so that the pet remains with the pet owner. Pet collars may also be used to store and/or convey information, such as identification information of the pet and/or the pet owner, address information of the pet, medical information of the pet, etc. The information may be provided via an electronic device and/or a non-electronic device.

Devices (e.g., electronic devices) may be used within a collar and/or may be coupled to a collar. For example, an electronic device may be used to store information of a pet and/or a pet owner. Although a pet collar will be described herein, the disclosure is not so limiting. Examples of devices that may house or couple to an electronic device may include one or more mechanisms worn by an animal for constraining the animal, storing information, and/or transmitting information of the animal, such as a harness, bracelet, anklet, belt, earring, headband, and the like. In other examples devices that may house or couple to an electronic device may include one or more attachment mechanisms, such as coats, boots, decorative clothing (e.g., ribbons), sweaters, hats, etc.

Electronic devices may be used within a collar and/or coupled to the collar, as described herein. Electronic devices may store information of the pet and/or track the movement and/or location of the pet. For example, electronic devices within or coupled to a collar may provide radio communication with a base station that may provide the location and/or proximity of the animal, Global Positioning System (GPS) may be used for locating the pet (e.g., over distances), etc. In examples electronic devices within or coupled to a collar may locate the pet via one or more other tracking methods, such as via Wi-Fi location tracking, cellular location tracking, etc.

Electronic devices may communicate with devices and/or objects other than servers and base stations, as described herein. For example, the electronic devices may communicate with other items, such as items found in a home. Such items may include, for example, pet beds, pet feeders, litter boxes, water bowls etc. The electronic devices may also, or alternatively, include (e.g., store) information relating to the pet and/or pet owner. The information may relate to location information or may be unrelated to location information. The information may be electronically stored and retrieved after the pet is located.

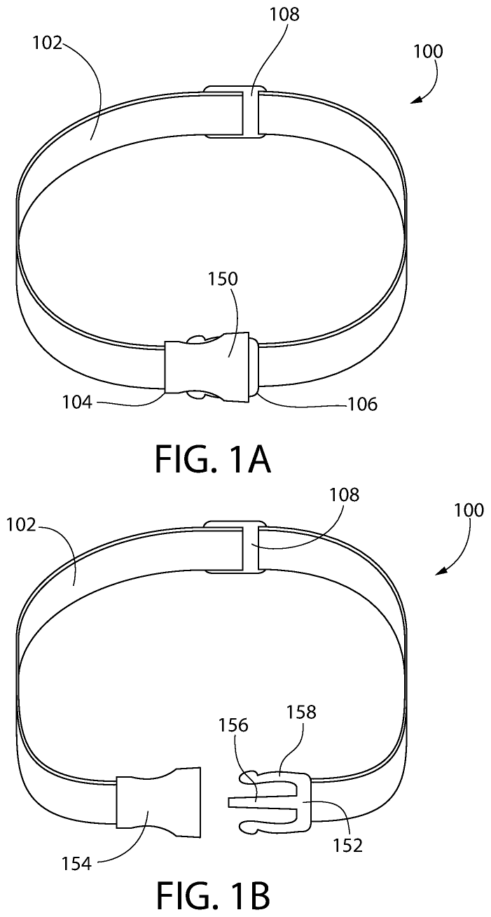

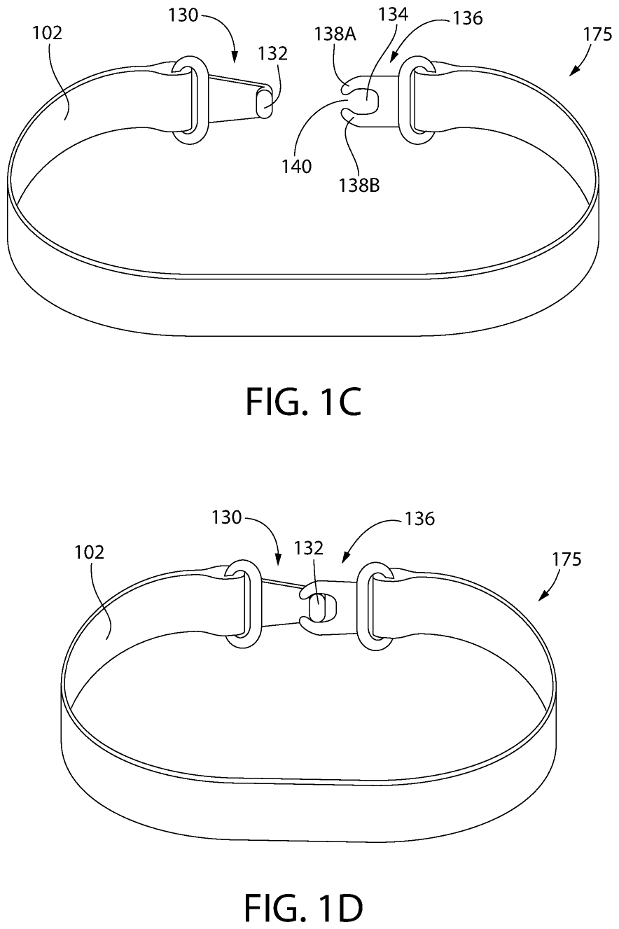

Referring now to the figures, FIGS. 1A, 1B show an example pet collar 100. FIG. 1A shows collar 100 in a closed configuration, in which the collar may be secured around a portion of the body (e.g., neck, leg, chest) of a pet. FIG. 1B shows collar 100 in an open configuration, in which the collar may be released from the pet and/or placed around the body of the pet.

Collar 100 may include one or more segments, such as strap 102. Strap 102 may be placed around a pet, as described herein. In examples strap 102 may be pliable and/or flexible, which may provide comfort for the pet. Although strap 102 may be constructed of synthetic fibers, in other examples strap 102 may be constructed of cotton, poly-cotton, or any other pliable material (e.g., synthetic or natural) in examples. Strap 102 may have terminal ends, such as a first terminal end 104 and a second terminal end 106.

Collar 100 may include one or more connecting portions 150, such as a buckle, clasp, ring, hook and loop fastener, loop, and the like. Connecting portion 150 may be formed on or coupled to one or more of the first terminal end 104 of strap 102 and second terminal end 106 of strap 102. Connecting portion 150, such as a buckle, may be constructed of a plastic material, although in examples connecting portion 150 may be constructed of rigid, semi-rigid, and/or non-rigid materials capable of engaging and disengaging connecting portion 150 (e.g., a buckle) from its respective buckle members.

Connecting portion 150 may include a male buckle member 152 and a female buckle member 154 for engagement with the male buckle member 152. In an example, buckle members 152 and 154 may be attached to respective terminal ends 104, 106 of strap 102. Male buckle member 152 may have a guide 156 positioned in the center of two biased anchors 158. Female buckle member 154 may have a corresponding guide cavity for receipt of guide 156 and corresponding anchor cavities for receipt of the two biased anchors 158. Upon insertion of male member 152 into female member 154, anchors 158 may snap into anchor cavities, thereby retaining collar 100 on the pet (e.g., on the neck, body, or other appendages of the pet).

Detachment of collar 100 (e.g., from a neck of a pet) may be accomplished by mutual application of pressure to anchors 158, thus biasing anchors 158 out of anchor cavities. Upon release of anchors 158 from anchor cavities, male buckle member 152 may be disengaged (e.g., laterally disengaged) from its respective female buckle member 154 and thereby disengages collar 100 from the neck of the pet.

Collar 100 may employ a length adjustment 108 which may allow collar 100 to adjust to a variety of pet sizes to achieve the desired circumference of the collar. Although FIG. 1A shows an example connecting portion 150 and length adjustment 108 for joining ends 104, 106 of collar 100 and lengthening collar 100, such is for illustration only and is non-limiting. For example, any and all attachment, detachment, and lengthening mechanisms, ranging from a knot to a clasp, may be used to perform the functionality of joining two opposite ends to enclose a circumference calculated to embody the neck, body, or other appendage of a pet and/or to extend the circumference of the collar 100.

FIGS. 1C, 1D show an example breakaway pet collar 175, although the breakaway pet collar 175 is for illustration purposes only and is non-limiting. FIG. 1C shows collar 175 in an open configuration, in which the collar 175 may be released from the pet and/or placed around the body of the pet. FIG. 1D shows collar 175 in a closed configuration, in which the collar may be secured around a body (e.g., neck) of a pet.

Collar 175 may be similar to collar 100, as described above. For example, collar 175 may include strap 102 and male/female connecting portions. Male member 130 may include a flange 132 which may be adapted to the opening 134 of the female member 136. Flange 132 may be configured to slide through opening 134 when the female member 136 is presented to the male member 130 at ninety degrees from the longitudinal axis, or vice-versa. Male member 130 may couple to strap 102, for example, via a strap connection. Female member 136 may couple to strap 102 in a manner similar to how male member couples to collar, or in a different manner.

Female member 136 may have a gap 140 which allows jaws 138A, 138B to spread open and release female member 136 from the flange 132 when break-away tension is applied. By increasing the width of gap 140, the amount of tension required to be sufficient for separation to occur may be less. Conversely, by decreasing the width of gap 140, the amount of tension necessary for separation may be increased. Such flexibility in controlling the amount of tension necessary for separation may allow collar 175 to be used by pets of various sizes and strengths. Although collar 175 and collar 100 may have different mechanisms for their respective connection portions, collar may be used interchangeably herein.

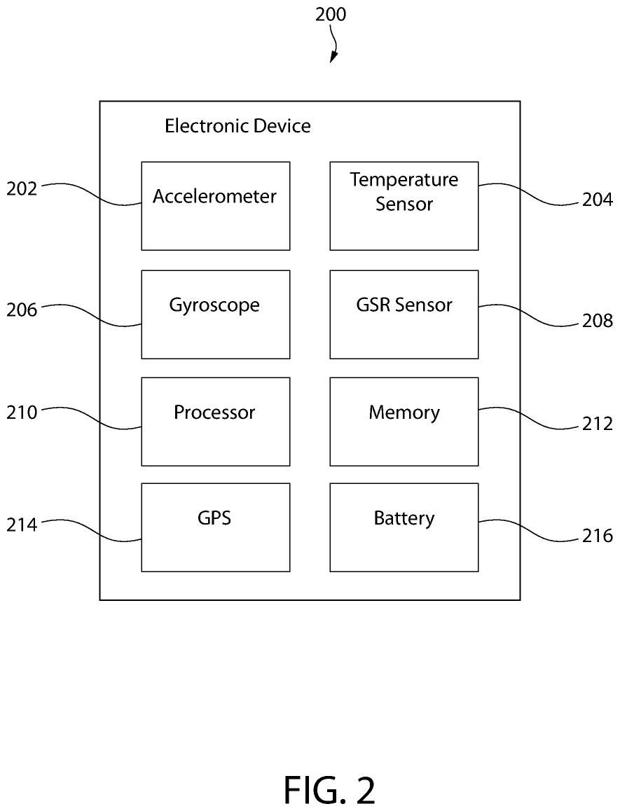

FIG. 2 shows an example electronic device 200. Electronic device 200 may reside within collar 100 and/or electronic device 200 may be coupled to the collar 100. Electronic device 200 may be used to store, determine, receive (e.g., actively receive, such as collect), and/or transmit information relating to the pet and/or the pet parent, including identification information, location information, medical information, biometric information, etc. The information may be real-time information. Electronic device 200 may be one or more processors, sensors, transponders, etc., including a combination thereof.

Electronic device 200 may identify biometric data of a pet, such as a pet's heart rate, blood pressure, temperature, moisture, etc., to determine and/or transmit a health condition of the pet. Electronic device 200 may determine and/or transmit location information of the pet, for example, to determine when the pet is inside/outside of the home of the pet. Electronic device 200 may be used to determine environmental conditions related to a pet, for example, the weather, temperature, pollen, etc. of the environment in which the pet is located. Electronic device 200 may have a microphone, speaker, camera, and/or recording capability. In examples, camera may be a video/photographic camera or other type of optical sensing device configured to capture images. Camera may be configured to capture single, static images of the area and and/or video images of the area. Electronic device 200 may have cellular or other WAN transmission capabilities, which may provide communication capabilities with an external device, such as a smartphone, tablet, server, or the like.

As described herein, electronic device 200 may include and/or communicate with various components. For example, electronic device 200 may include and/or communicate with one or more of accelerometer 202, temperature sensor 204, global positioning system (GPS) sensor 214, gyroscope 206, galvanic skin response (GSR) sensor 208, processor 210, memory 212, and/or battery 216. As an example, electronic device 200 may communicate with one or more components (e.g., GPS sensor 214) that are external to the electronic device 200, via a Bluetooth connection. Processor 210 may store, receive (e.g., actively receive), and/or transmit identification information of the pet and/or pet owner. For example, processor 210 may store, receive (e.g., actively receive), and/or transmit real-time information of the pet and/or pet owner. Electronic device 200 (e.g., processor 210 within electronic device 200) may be within (e.g., integrated within) collar 100 and/or coupled to collar 100. Processor 210 may be configured to translate and/or store data from components housed within electronic device 200 (e.g., accelerometer 202, gyroscope 206, magnetometer, etc.). Processor 210 may be configured to permit electronic device 200 to function and/or assist in one or more modes, such as active mode, sleep mode, transmit mode, onboarding mode, etc.

Electronic device 200 may identify the pet and/or the pet owner, track the location of the pet, monitor biometric information of a pet or activity (e.g., heart rate, steps, calories burned, etc.) of the pet, environmental conditions related to a pet. Electronic device 200 may identify such information via one or more sensors, such as accelerometers, gyroscopes, temperature sensors, heart rate sensors, magnetometers, electrocardiogram (EKG, otherwise known as ECG) electrodes, photoplethysmography (PPGs) and/or reflection mode PPGs (PPGr) sensors, or one or more other sensors of electronic device 200 or external to electronic device 200 that detect information of an animal. For example, electronic device 200 may identify biometric data of the animal via biosensors to determine health indicators of the animal, such as glucose, cortisol, serotonin, serum symmetric dimethylarginine (SDMA), and other indicators of the animal. Processor 210 may track such data over certain time periods. An example processor 210 may be an ARM Cortex M0-M3, or the like.

Accelerometer 202 may measure an activity and/or movement of a pet. For example, temperature sensor 204 may measure the pet's body temperature, gyroscope 206 may measure the pet's orientation, GSR Sensor 208 may measure galvanic skin resistance (GSR). For instance, the GSR sensor 208 may measure the amount of sweat or moisture detected on the body of the pet. GPS 214 may identify and/or determine the location (e.g., current location) of the pet. Memory 212 may be of any size. To perform proximity sensing, electronic device may include a cellular chip, Bluetooth (e.g., Bluetooth low energy), and the like.

Battery 216 may be contained within (e.g., self-contained within) a housing of electronic device 200 and/or may be located about housing of electronic device 200. Battery 216 may store charge for operation of electronic device 200. Battery 216 may be removable and/or modular. In some examples battery 216 may be located in an attachment to collar, although in examples battery 216 may be located within (e.g., integrated within) collar. Battery 216 may be chargeable while electronic device 216 is attached to the pet. For example, an interface may be provided through housing of electronic device 200 that may allow the battery 216 to be charged while electronic device 200 is attached to collar 100. The interface may be, for example, a USB interface, induction pins, wireless communications, etc., that allow the battery 216 to be accessed and charged while the electronic device 200 is attached to collar 100. Although a Li—Po battery may be used, such battery is for illustration purposes only and any type of battery may be used.

Electronic device 200 may include one or more components, such as a light source. The light source may an LED light source, for example. Light source may be indicators, such as indicators 2604. The light source may provide one or more indicators having one or more colors and other effects. For example, light source may have one or more light indicators that may be different colors, the same colors, or a combination of the two. The light indicators may blink at speeds (e.g., fast intervals, slow intervals), etc. The light indicators may represent aspects of the pet, such as the pet's activity (e.g., eating/drinking activity, sleeping activity, exercise activity, etc.). The light indicators may represent aspects of the environment surrounding electronic device 200, such as the weather, precipitation, moisture, humidity, and the like. The light indicators may represent aspects of electronic device 200, such as an indication of sufficient or lack of power of battery 216, of battery 216 being charged, and the like. The light indicators may represent data receipt and/or transmission. For example, the light indicators may represent successful data receipt and/or transmission and/or unsuccessful data receipt and/or transmission.

Collar 100 and/or electronic device 200 may be waterproof, water resistant, and/or hypoallergenic in examples. For example, electronic device 200 may include a housing that prevents or resists water from entering the housing. Preventing or resisting water from entering the housing of electronic device 200 may prevent destruction or damage to electronic device 200 and/or one of the components/devices/sensors within housing storing electronic device 200.

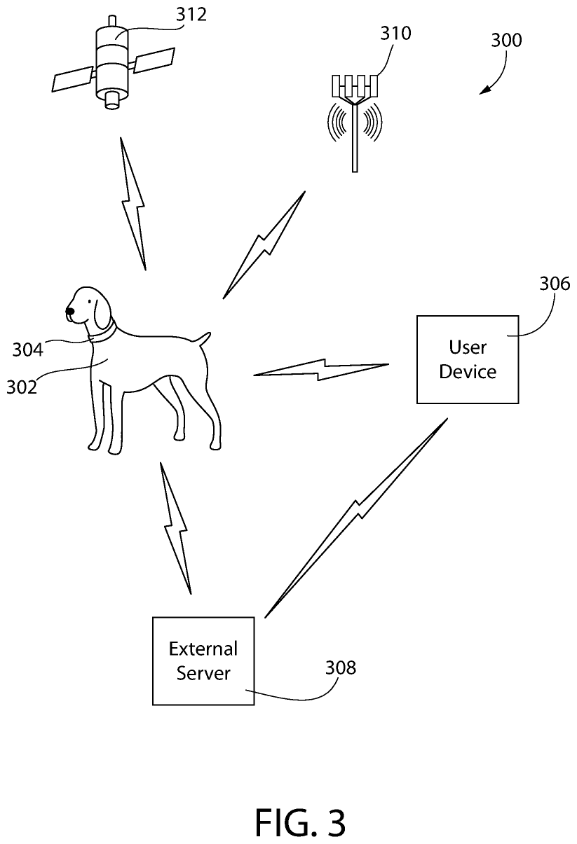

FIG. 3 shows an example system 300 which includes a pet 302 and collar 304. Collar 304 may be one or more collars, such as collar 100, 175 described herein. Collar 304 may include one or more electronic devices or couple to one or more electronic devices, such as electronic device 200. System 300 may include a communication between collar 302 and one or more external devices, such as user devices 306, server 308, GPS 312, and cellular network 310.

System 300 may include a network configured to enable exchange of electronic communications between devices connected to the network. In examples the network may facilitate communications between collar 304 (e.g., electronic devices housed within or coupled to collar 304), one or more user devices 306, server 308 (e.g., an external server, such as a cloud server), as well as one or more electronic devices. The network may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network 310, and Digital Subscriber Line (DSL)), radio, television, cable, satellite, Bluetooth (e.g., Bluetooth classic and Bluetooth low energy), and/or one or more other delivery or tunneling mechanisms for carrying data. Electronic device 200 may include one or more antennas, such as two antennas, for communicating. In an example in which electronic device 200 includes one or more (e.g., two) antennas, one antenna may be used to communicate via one protocol (e.g., Bluetooth) and the one or more other antennas may be used to communicate via one or more other protocols (e.g., Wi-Fi).

System 300 may include multiple networks or subnetworks, each of which may include, for example, a wired or wireless data pathway. A network may include a circuit-switched network, a packet-switched data network, or any other network able to carry electronic communications (e.g., data or voice communications). For example, the network may include networks based on the Internet protocol (IP), the PSTN, packet-switched networks based on IP, or other comparable technologies. The network may include one or more networks that include wireless data channels and wireless voice channels. The network may be a wireless network, a broadband network, or a combination of networks including a wireless network and a broadband network.

One or more components of an electronic device (such as electronic device 200) may be housed within a collar, as described herein. In other examples an electronic device may be housed within an attachment that may be coupled (e.g., detachably coupled) to collar. Electronic device may be housed within collar and/or about collar in one or more ways, as described further herein.

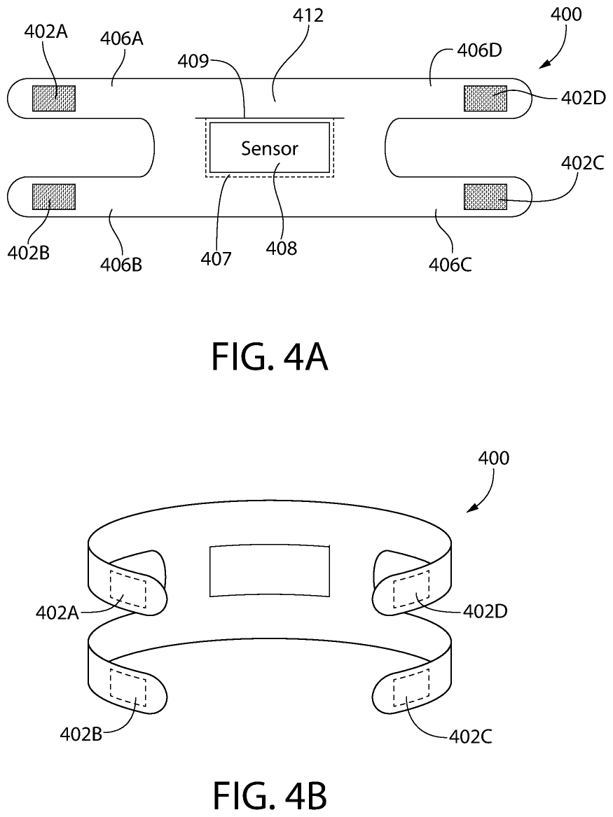

FIGS. 4A, 4B show an example attachment 400 having an attachment body 412 configured to house sensor 408. It should be understood that sensor and electronic device may be used interchangeably. For example, sensor 408 may be an electronic device, such as electronic device 200 (e.g., sensor, processor) described herein. Attachment body 412 may include a front side (FIG. 4A) and a back side (FIG. 4B). Collar 100 may be formed with attachment body 412 and/or attachment body 412 may be separate from collar 100. Attachment 400 may be configured to couple (e.g., attach) to collar 100. Attachment 400 may include one or more mechanisms to prevent, or mitigate, attachment 400 from twisting or moving along the collar.

Attachment body 412 may include one or more attachment devices/mechanisms for attaching to collar 100. For example, attachment body 4 may include one or more connection elements 402A, 402B, 402C, 402D (collectively connection elements 402) having one or more attachment mechanisms, such as hook and loop fastener, buttons, ropes, loops, glue, tape, and the like. One or more connection elements 402 of attachment body 412 may attach to one or more other connection elements 402 to attach attachment 400 to collar 100. Attachment 400 may be formed in one or more configurations. For example, attachment body 412 of attachment 400 may be configured in a butterfly form, such as shown on FIGS. 4A, 4B, although such configuration is for illustration purposes and is not limiting. For example, attachment body 412 may be formed in an oval configuration, square configuration, triangular configuration, and the like.

Attachment body 412 may include one or more legs, such as legs 406A, 406B, 406C, 406D (collectively 406). One or more connection elements 402 having attachment mechanisms may be formed on one or more legs 406. Legs 406 of attachment body 412 may wrap around collar 100 to secure attachment 400 to collar 100. For example, legs 406 of attachment body 412 may fold longitudinally to wrap around a collar to secure attachment 400 to a collar, as shown on FIG. 4B. However, legs 406 of attachment body 412 may fold in one or more other configurations to wrap around a collar to secure attachment 400 to a collar, such as by folding along a transverse axis of attachment body 412.

Attachment 400 may wrap around collar 100 such that a hook and loop fastener on connection elements 402A engages (e.g., couples) with corresponding hook and loop fastener on another connection element (e.g., connection element 402B), although such configuration is for illustration purposes only and is not limiting. In other examples, one or more connection elements 402 may couple with one or more other connection elements 402. In an example legs 406 may diagonally wrap around collar 100 such that connection element 402D attaches to connection element 402B and/or connection element 402C attaches to connection element 402A. Connection elements 402 having attachment mechanisms may be positioned in one or more locations of collar 100. For example, connection elements 402 may be positioned in a center of attachment body 412 and/or connection elements may be positioned on legs 406 of attachment body 412.

Attachment body 412 may be configured to accept sensor 408 (e.g., electronic device 408), for example, within a cavity 407 of attachment 400. Sensor 408 may be inserted into cavity 407 within an opening, such as opening 409. In an example electronic device 408 may be housed in cavity 407 within a front of attachment 400 and/or a back of attachment 400. For example, electronic device may be inserted into a front of attachment body 412 via a slit, a hole, opening 409, etc. An enclosure element, such, as a zipper, hook and loop fastener, or the like, may be used on opening 409 to retain electronic device 408 within cavity 407 of attachment 400. The front of attachment 400 may be coupled to collar 100 such that the electronic device 408 is facing and/or touching the collar 100. Electronic device 408 may be inserted into attachment by the pet owner and/or by the manufacturer of the attachment. In examples in which the electronic device 408 is inserted within a front of the attachment body 412, wrapping the front side of the attachment body around the wearable collar may expose an outside of the attachment body and cause the front side of the attachment body housing the electronic device 408 to be inaccessible by the animal.

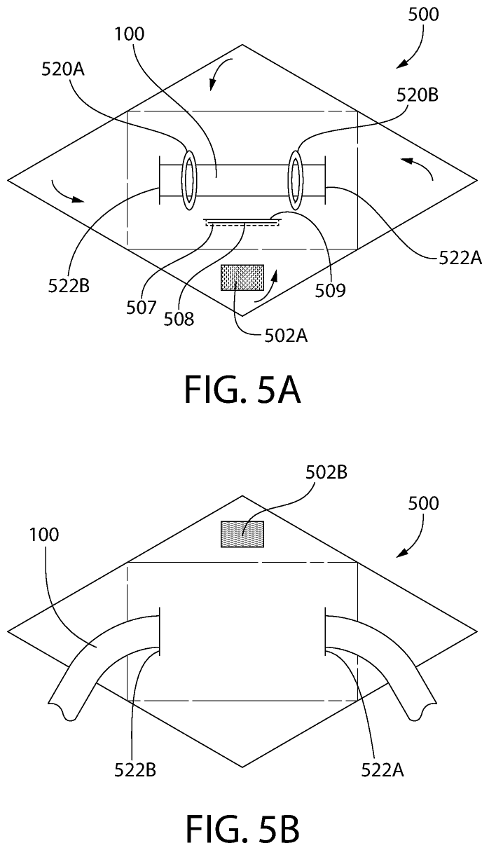

FIGS. 5A, 5B show an example attachment 500 configured to house electronic device 508, which may be electronic device 200 described herein. Attachment 500 may be separate from collar 100 and/or may be configured to couple (e.g., attach) to collar 100. Attachment 500 may include a front side (FIG. 5A) and a back side (FIG. 5B). Attachment 500 may include one or more portions 502A, 502B (collectively 502) having attachment mechanisms for attaching one or more portions 502 of attachment 500 to one or more other portions 502 of attachment 500 so that attachment 500 couples to collar and/or secures electronic device 508 to collar. For example, attachment 500 may include attachment mechanisms/elements such as hook and loop fastener, buttons, ropes, loops, glue, tape, snaps, hook and eye closures, elastic (e.g., elastic closures), and the like, on one portion 502 of the attachment 500. Such attachment mechanisms may be configured to attach the one portion of attachment 500 to another portion of attachment 500.

As shown on FIG. 5A, collar 100 (e.g., strap of collar 100) may enter a first portion 522A of attachment 500 and exit a second portion 522B of attachment 500, although collar 100 may enter and exit attachment 500 in one or more ways. In examples attachment 500 may also, or alternatively, include other attachment mechanisms, such as an O-ring 520A, 520B. The other attachment mechanisms may provide additional support and/or rigidity of attachment 500 to collar. In examples attachment 500 may other attachment mechanisms, fabric, or other mechanism to assist attachment 500 in being held by collar 100, for example, so that attachment 500 does not move along collar 100. Although FIGS. 5A, 5B show attachment 500 formed in a triangular configuration, such configuration of attachment 500 is for illustration purposes only and attachment 500 may be formed as a square, rectangle, pentagon, etc.

Attachment 500 may be configured to accept electronic device 508, which may be the electronic device described herein. Electronic device 508 may be housed within cavity 507 located on a front of attachment 500 and/or back of attachment 500. For example, electronic device 508 may be inserted into opening 509 on a front of attachment 500 via a slit (as shown on FIG. 5A), a hole, a pouch opening, a zipper, a fold within the collar, etc. Slit may be adjacent to collar 100 passing through attachment 500, although slit may located in one or more locations of attachment 500, such as under collar 100, remote from collar 100 passing through attachment 500, etc. Electronic device 508 may be inserted into attachment 500 by the pet owner and/or by the manufacturer of attachment 500.

Attachment 500 may be configured to fold. For example, one or more portions 502 may fold around or away from collar 100. Folding one or more portions 502 around collar 100 may enable a coupling of one portion (e.g., portion 502A) of attachment 500 to another portion (e.g., portion 502B) of attachment 500. Coupling of one portion of attachment 500 to another portion of attachment 500 may cause attachment 500 to engage around collar 100, such that attachment 500 may be attached to collar 100. Attachment 500 may be removed from collar 100 upon a force being used to disengage the one portion of the attachment 500 from the other portion of attachment 500.

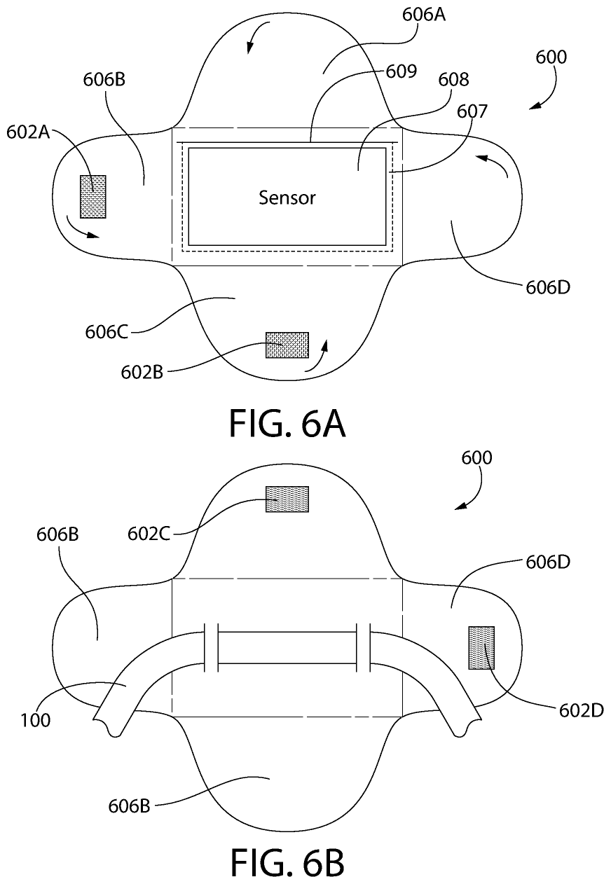

FIGS. 6A, 6B show an example attachment 600. Attachment 600 may include one or more holding portions for holding a portion of collar 100 or having collar 100 pass through attachment 600. Attachment 600 may include two or more legs 606A, 606B, 606C, 606D (collectively 606) that may wrap around and/or otherwise attach attachment 600 to collar 100. Legs 606 may be formed in one or more configurations, shapes, sizes, etc. For example, portions 606 may be curved, straight, zig-zag, and the like. For example, while FIGS. 5A, 5B show legs of attachment 500 forming straight outer lines, FIGS. 6A, 6B show legs of attachment 600 forming curved outer lines.

Attachment 600 may include one or more portions 602A, 602B, 602C, 602D (collectively 602) having attachment mechanisms, such as hook and loop fastener, buttons, ropes, loops, glue, tape, snaps, hook and eye closures, elastic (e.g., elastic closures) and the like. Attachment mechanisms may be used for attaching one portion (e.g., 602A) of attachment 600 to another portion (e.g., 602D) of attachment 600. By attaching one portion of attachment 600 to another portion of attachment 600, attachment 600 may be coupled to collar 100.

Attachment 600 may be configured to accept an electronic device, such as the electronic device described herein. In an example electronic device 608 may be housed within front of attachment 600 and/or back of attachment 600. For example, electronic device 608 may be inserted into a front of attachment 600 via a slit, a pouch, a hole, etc. The front of attachment 600 may be coupled to collar 100 such that the electronic device 608 is facing and/or touching collar 100 and/or facing and/or touching the pet. Electronic device 608 may be inserted into attachment by the pet owner and/or by the manufacturer of the attachment. Mechanisms, such as a zipper, button, fold, snaps, elastic closures, and the like may be used to prevent the pet from accessing electronic device 608.

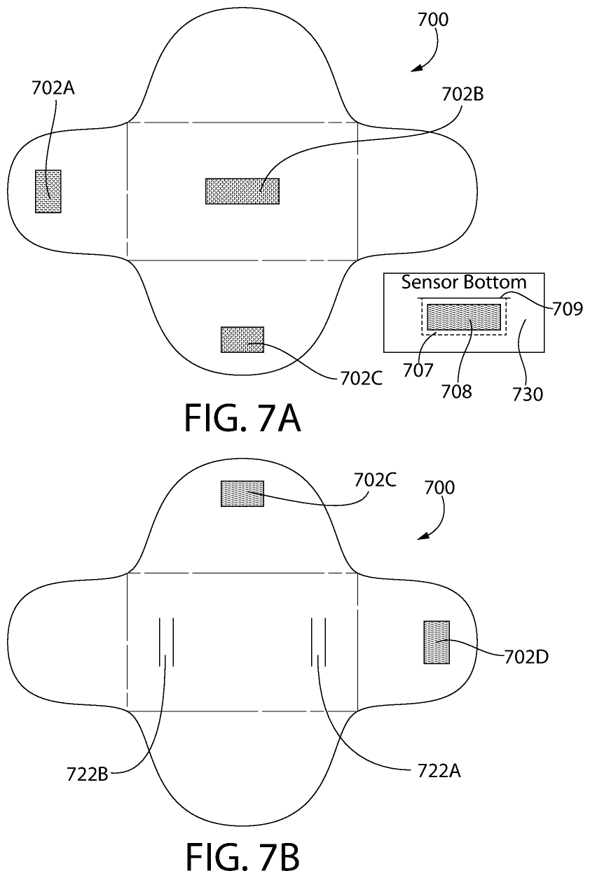

FIGS. 7A, 7B show an example attachment 700 and appendage 730 that may be external to attachment 700 and may attach to attachment 700 (e.g., via hook and loop fastener, or the like). Appendage 730 may provide a cavity in which electronic device 708 may be housed. For example, appendage 730 may include a pouch, slit, or other configuration for holding electronic device 708. The cavity may be formed when appendage 730 attaches to attachment 700. The cavity may be formed such that when appendage 730 is attached to attachment 700 electronic device 708 is facing attachment 700 so that electronic device 708 is secured from pet. In examples appendage 730 may attach over collar 100, which may enter attachment 700 via pass throughs 722A, 722B, although in other examples appendage 730 may attach under collar 100 (e.g., passing through attachment 700), adjacent to collar 100, etc.

Attachment 700 may include one or more portions 702A, 702B, 702C, 702D (collectively 702) having attachment mechanisms, such as hook and loop fastener, buttons, ropes, loops, glue, tape, snaps, hook and eye closures, elastic (e.g., elastic closures) and the like. Attachment mechanisms may be used for attaching one portion (e.g., 702A) of attachment 700 to another portion (e.g., 702D) of attachment 700. By attaching one portion of attachment 700 to another portion of attachment 700, attachment 700 may be coupled to collar 100.

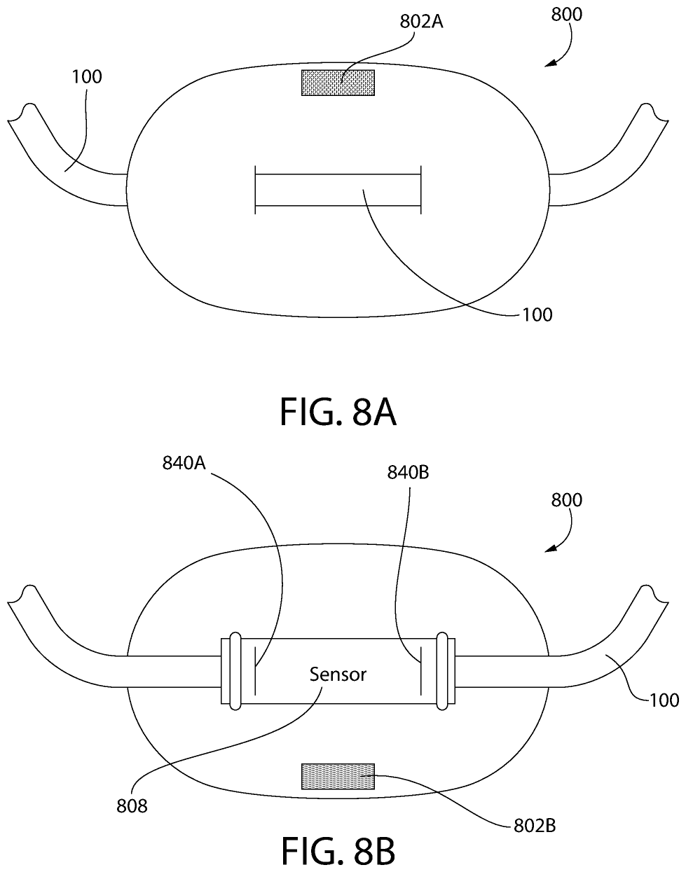

FIGS. 8A, 8B show an example attachment 800. Attachment 800 may include one or more portions 802A, 802B (collectively 802) having attachment mechanisms, such as hook and loop fastener, buttons, ropes, loops, glue, tape, snaps, hook and eye closures, elastic (e.g., elastic closures) and the like. Attachment mechanisms may be used for attaching one portion (e.g., 802A) of attachment 800 to another portion (e.g., 802B) of attachment 800. By attaching one portion of attachment 800 to another portion of attachment 800, in other examples attachment 800 may be coupled to collar 100.

Attachment 800 may be configured to accept electronic device 808, which may be the electronic device described herein. In an example electronic device 808 may be housed within the front of attachment 800 and/or the back of attachment 800. As an example, portions of electronic device 808 may be inserted into a front of attachment 800 via a slit, a pouch, a hole, etc. For example, corners and/or sides of electronic device 808 may be secured by slits 840A, 840B. In such examples, portions of the electronic device 808 may be exposed (e.g., portions of electronic device 808 may be outside of slits 840A, 840B). When secured by the attachment 800, electronic device 808 may face and/or touch collar 100. By facing electronic device 808 towards collar, the pet may be prevented from accessing electronic device 808. In examples an external covering device (such as appendage 730) may be used to cover electronic device 808.

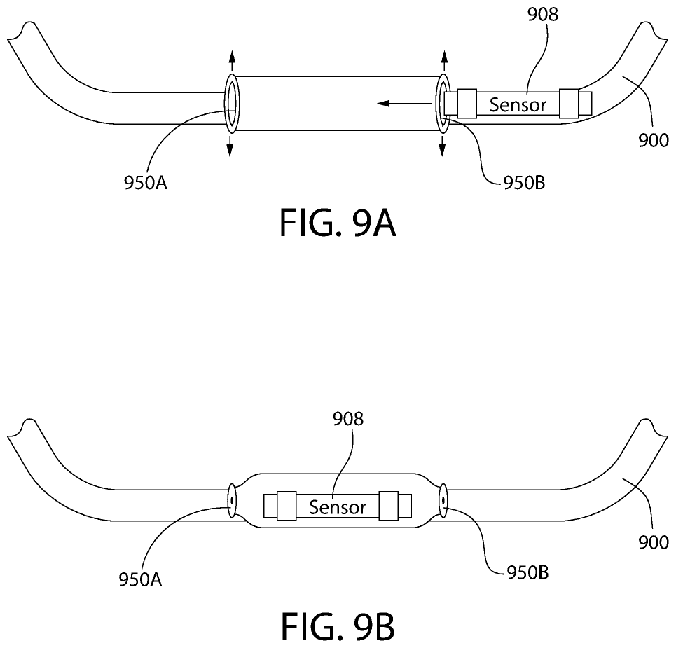

As described herein, an electronic device may be attached to collar (e.g., via an attachment). In other examples an electronic device may be housed in or about collar. FIGS. 9A, 9B show electronic device 908 being housed in collar 900. Collar 900 may be formed of one or more stretch (e.g., elastic) bands. Upon stretching the one or more stretch bands, one or more openings 950A, 950B (collectively 950) may be provided and/or exaggerated. Openings 950 may be configured as, or provide access to, a pocket, slit, etc. For example, when the stretch band of collar 900 is not stretched, opening 950 may be closed (e.g., substantially closed), as shown on FIG. 9B. When opening 950 is closed electronic device (e.g., sensor) 908 may be prevented from entering into opening 950 or exiting from opening 950, a shown on FIG. 9B. When the stretch band of collar 900 is stretched, a pocket, slit, or the like may open (e.g., further open), as shown on FIG. 9A. Electronic device 908 (e.g., sensor) may be inserted into one or more of the openings 950 of collar 900 when the stretch band is stretched and electronic device 908 may be retained within openings 950 upon stoppage of the stretch of the stretch band, as described herein and shown on FIG. 9B.

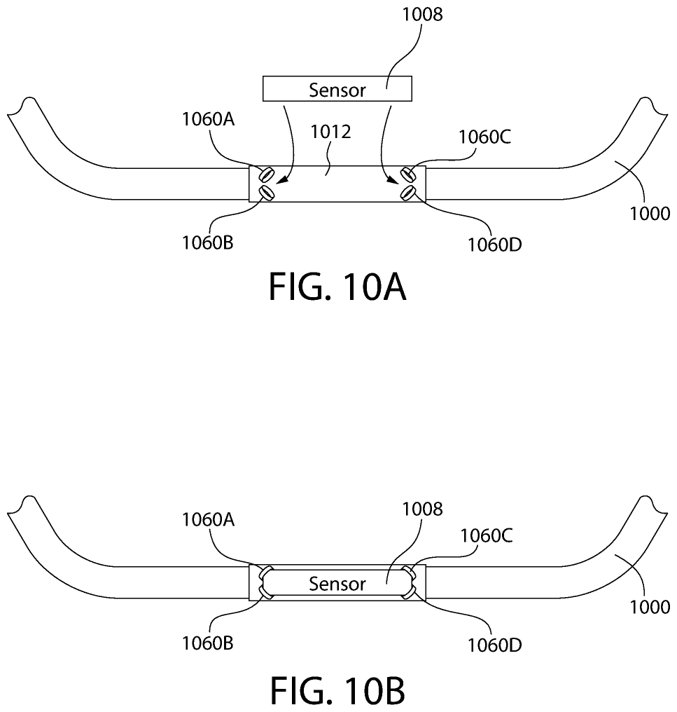

Electronic device may be inserted into one or more portions of a collar (such as collar 100, collar 175, collar 1000, or the like). As shown on FIGS. 10A, 10B, collar 1000 may include one or more perturbances, such as perturbances 1060A, 1060B, 1060C, 1060D (collectively perturbances 1060). Perturbances 1060 may be included on a stretchy band of collar 1000, as described herein, although collar 1000 may be formed on stretchy and/or non-stretch bands. Perturbances 1060 may be used to hold one or more portions of electronic device 1008, such as one or more corners of electronic device 1008. Perturbances 1008 of collar 1000 may hold one or more portions (e.g., corners) of electronic device 1008 upon stretchy bands of collar 1000 being stretched. For example, the stretching of the bands may expand the holding area 1012 of collar 1000. Upon the stretching force being released, perturbances 1060 may hold (e.g., snugly hold) the portions (e.g., corners) of electronic device 1008.

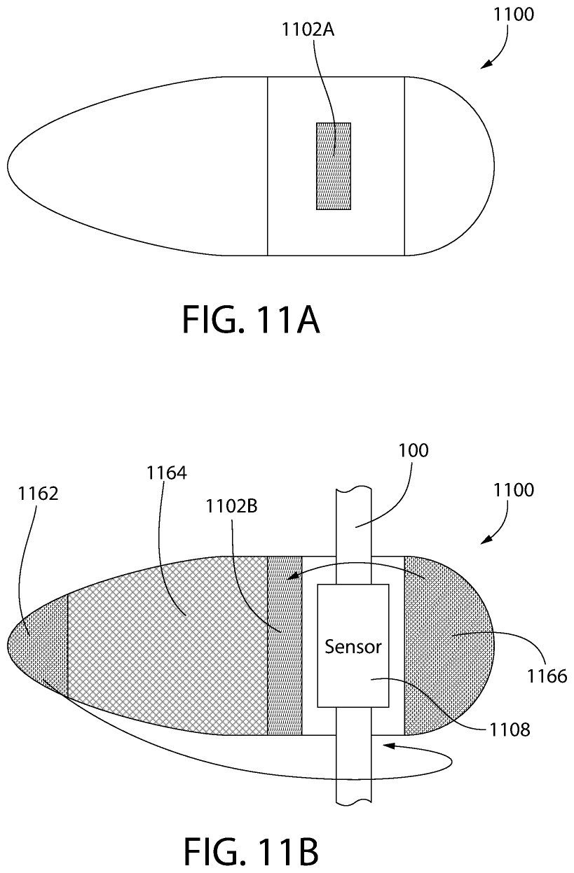

FIGS. 11A, 11B show an example attachment 1100 that may couple to a collar, such as collar 100 and/or collar 175. Attachment 1100 may house electronic device 1108. In examples attachment 1100 may be formed of a material (e.g., elastic material) that may stretch. For example, attachment may include one or more portions (such as portions 1162, 1164, 1166) that may be formed of an elastic material that may allow the attachment 1100 to be coupled to collar 100 via a folding and/or stretching of the one or more portions 1162, 1164, 1166.

Attachment 1100 may include one or more attachment portions 1102A, 1102B (collectively attachment portions 1102) having attachment mechanisms for attaching one or more portions 1102 of attachment 1100 to one or more other portions 1102 of attachment 1100 so that attachment 1100 couples to collar 100 and/or secures electronic device 1108. For example, attachment 1100 may include hook and loop fastener, buttons, ropes, loops, glue, tape, snaps, hook and eye closures, elastic (e.g., elastic closures) and the like, on one portion 1102 of attachment 1100. Such attachment mechanisms may be configured to attach one portion of attachment 1100 to another portion of attachment 1100. As described herein, one or more portions of attachment 1000 may be formed of an elastic or other stretchy material. Forming the portions with such stretchy material may allow portions of attachment to be stretched, for example, when wrapping attachment 1100 around collar 100. Such stretching of the attachment may result in the attachment having a snug fit around the collar.

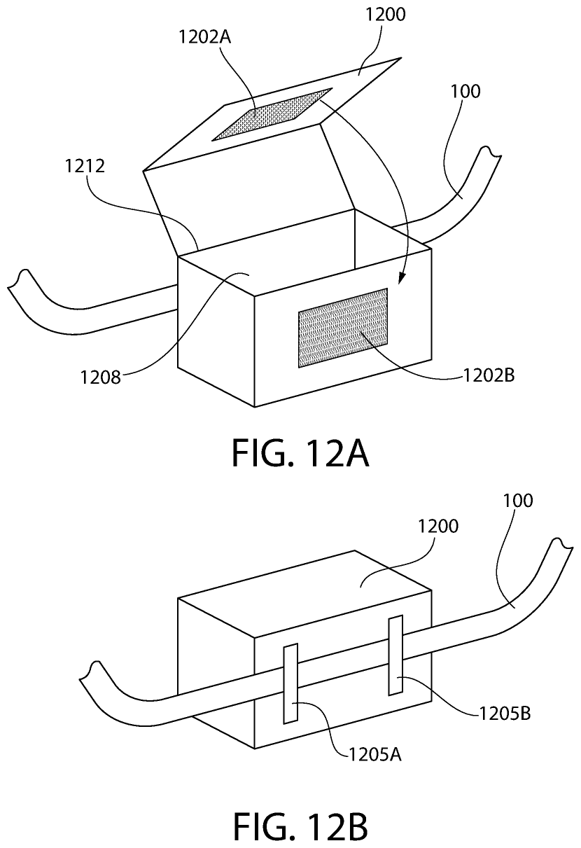

FIGS. 12A, 12B show an example casing 1200 (e.g., pouch) that includes a flip-top closing. In examples collar 100 may pass through one or more holding elements 1205A, 1205B of casing 1200 to engage with and/or hold casing 1200 to collar 100, although in other examples collar 100 may engage and/or hold casing 1200 in one or more other ways, such as through body of casing 1200.

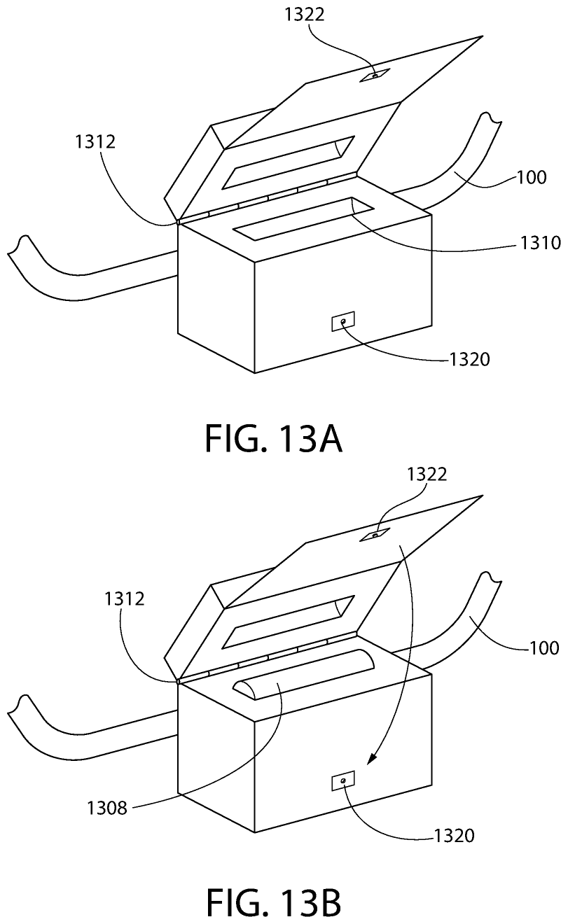

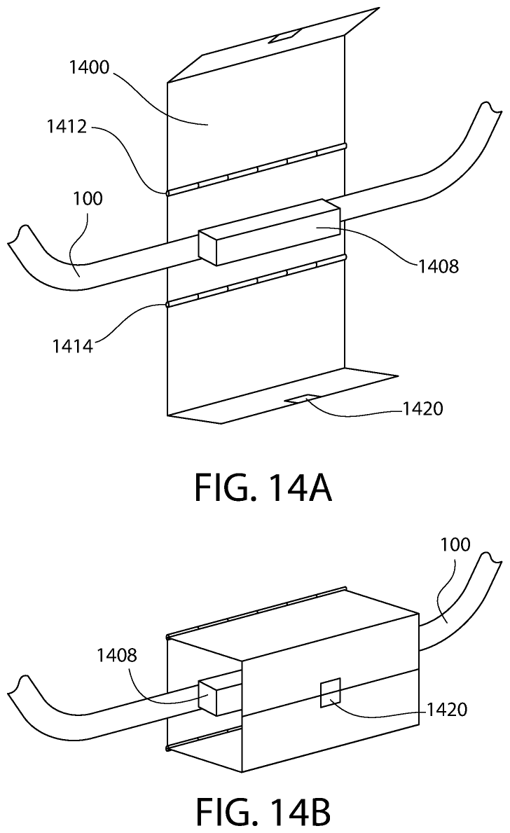

Casing 1200 may include one or more hinges 1212 for opening and/or closing portions of casing 1200. For example, FIGS. 12A, 12B, 13A, 13B show examples of respective casings 1200, 1300 having a single hinge 1212, 1312, and FIGS. 14A, 14B show examples of a double hinged casing 1400 having double hinges 1412, 1414, although such examples are not limiting and casings may have one, two, or more hinges. Casing (e.g., casing 1200) may be formed of two or more casing pieces (e.g., rigid pieces) that may be placed together to lock the two or more casing pieces in place and/or together. For example, a casing may have hook and loop fastener attachments (such as hook and loop fastener attachments 1202A, 1202B), a snap closure (such as male snap closure 1322 and female snap closure 1320), or the like, to open and close the casing via the two or more casing pieces. The casing may be opened and closed via a hinge (such as hinge 1212, 1312) in which one or more of the casing pieces may be configured to swing away from each other.

Casing may include a cavity for housing an electronic device. For example, casing 1200 may include cavity 1210 and casing 1300 may include cavity 1310 for holding an electronic device. Cavity 1310 may be shaped to house a particular electronic device 1308, generically shaped, etc. In examples, a cavity may be formed via two layers of a material (e.g., Kevlar).

FIGS. 14A, 14B show an example attachment 1400 having double hinges 1412, 1414 that open and close a casing of attachment 1400. Attachment 1400 may couple to collar 100. For example, attachment 1400 may detachably couple to collar 100 via a base portion. Attachment 1400 may include one or more hinges. For example, double hinges 1412, 1412 of attachment 1400 may allow attachment 1400 to open (e.g., fully open), as shown on FIG. 14A or close, as shown on FIG. 14B. As shown on FIGS. 14A, 14B, a first flap may be coupled to the base portion (via hinge 1412) and a second flap may be coupled to the base portion (via hinge 1414). The first hinge and the second hinge may be configured to position the respective first flap and second flap from a position extending longitudinally from the base portion to a position that is substantially perpendicular to the base portion. The flaps may comprise a bending portion. For example, a first bending portion may extend from the first flap. The first bending portion may be configured to bend towards the second flap. The second bending portion may extend from the second flap. The second bending portion may be configured to bend towards the first flap.

One or more of flaps or base portion may be made of a rigid material, although in examples one or more of flaps or base portion may be made of a semi-rigid or flexible material. Electronic device 1408 may couple to attachment 1400 via a cavity or holding area. Electronic device 1408 may be fixed to a portion of attachment 1400, for example, via adhesive, hook and loop fastener, clasps, and the like. Attachment 1400 may be closed via one or more fastening devices (e.g., reusable closures), such as a clasp 1420, hook and loop fastener, a button, a loop, or a buckle. A fastening device, located on the first flap, may couple with another (e.g., corresponding) fastening device located on second flap. Fastening device may close the attachment 1400 (e.g., by fastening the first flap with the second flap), retain the electronic device 1408 within the cavity of the attachment 1400, and/or prevent access of the electronic to the pet.

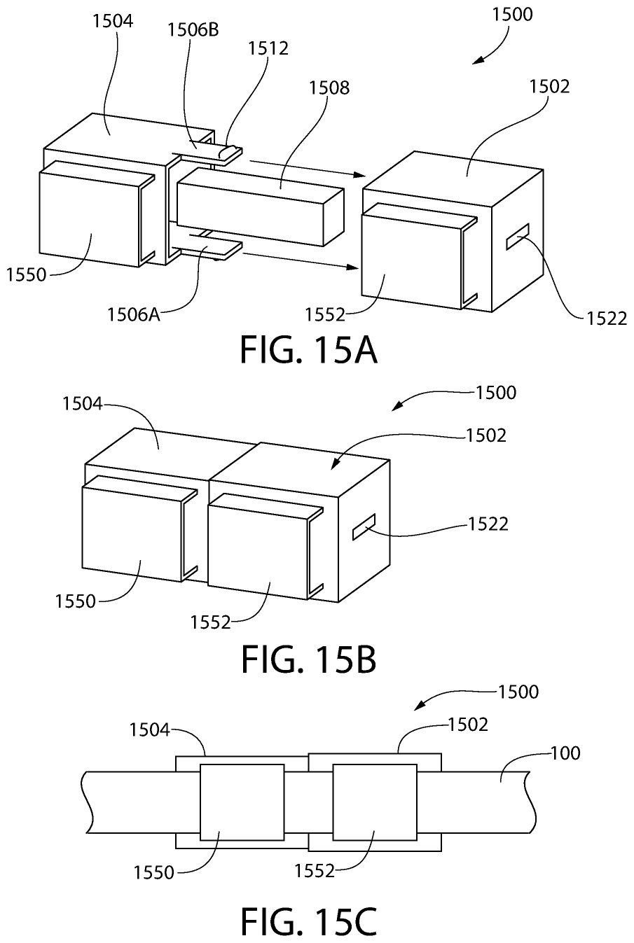

FIGS. 15A, 15B, 15C show an example attachment 1500 configured as a snap enclosure. For example, attachment 1500 may include a first component (e.g., portion) 1502 and a second component (e.g., portion) 1504. First component 1502 and a second component 1504 may be hollow (e.g., may include a cavity). First component 1502 and a second component 1504 may be sized the same, although in some examples first component 1502 and a second component 1504 may be of different sizes. When first component 1502 and a second component 1504 are sized the same, the portions may abut against one another when in a closed position. When first component 1502 and a second component 1504 are of different sizes, one component may fit (partially fit) within the other component. Electronic device 1508 may be contained in one or more of first component 1502 and/or second component 1504.

First component 1502 and second component 1504 may couple with each other via respective coupling elements. Coupling elements may be one or more elements to couple first component 1502 and second component 1504. Coupling element of first component 1502 may be the same as coupling element of the second component 1504, although in examples coupling element of first component 1502 may be different than coupling element of the second component 1504. Coupling element may be an arm such as arm 1506A that includes flange 1512. Flange 1512 of second component 1504 may engage with and couple to a coupling element of first component 1502 (e.g., a recess, detent, etc.). Although FIG. 15 shows arm 1506B having flange 1512, coupling element may be one or more other elements configured to couple first component 1502 and second component 1504. For example, coupling element may be one or more of a ball and socket, clips, magnets, adhesive, etc. One or more mechanisms (e.g., flanges 1512) may be located on one or more arms 1506A, 1506B extending from second component 1504. Mechanism (e.g., flange 1512, ball and socket) may engage with an inner wall (or protuberance, socket, etc., within wall, etc.) of first portion 1502. As shown on FIG. 15B, electronic device 1508 may be contained (e.g., entirely contained) within a cavity formed of cavities of first component 1502 and second component 1504. For example, electronic device 1508 may be contained (e.g., entirely contained) within a cavity of attachment 1500 when first portion 1502 and second portion 1504 are coupled to one another.

Attachment 1500 may couple to collar 100. For example, attachment may include one or more couplers attached to one or more of first component 1502 or second component 1504. Collar 100 may couple to couplers 1550, 1552 via collar 100 passing through one or more openings of couplers 1550, 1552, as shown on FIG. 15C. In such examples, collar 100 may be coupled to attachment 1500 when first portion 1502 and second portion 1504 are in an open position and when first portion 1502 and second portion 1504 are in a closed position.

First component 1502 and/or second component 1504 may include an interface, such as interface 1522. Interface 1522 may be used to charge a battery contained within first component 1502 and second component 1504. Interface 1522 may be used to access and/or provide information to electronic 1508 housed within first component 1502 and second component 1504. For example, interface 1522 may be a USB interface, induction pins, etc., used to access and/or provide information to electronic 1508 housed within first component 1502 and second component 1504, although in other examples electronic device 1508 may access and/or provide information via other techniques, such as via wireless techniques. Further, the techniques relating to interface 1522 may be used in one or more of the other collars and/or adapters, as described herein.

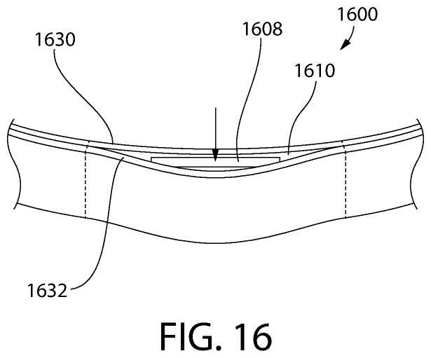

FIG. 16 shows an example collar 1600 with a pocket for housing an electronic device. For example, collar 1600 may include two or more layers, such as a first layer 1630 and a second layer 1632. A space 1610 may be formed between first layer 1630 and second layer 1632. Space 1610 may be a slit, a pouch, a pocket, and the like. Electronic device 1608 may be housed within space 1610. Although FIG. 16 shows an opening between first layer 1630 and second layer 1632, examples may include one or more additional layers that may form one or more additional spaces (e.g., pockets). The additional layers may extend from the first layer 1630 and/or the second layer 1632, in examples, although in examples the additional layers may be formed within first layer 1630 and/or the second layer. Collar 1600 may include a closing device that may couple one or more of the layers with one or more other layers of the collar 1600. Closing device may be configured to close the opening (e.g., pocket) and/or to secure the electronic device 1608 within the opening. Closing device may include a hinge, for example, that hinges upon the first layer 1630 or the second layer 1632 to close the collar 1600, although other examples of closing device may include hook and loop fastener, buttons, snaps, loops, snaps, hook and eye closures, elastic (e.g., elastic closures), and the like, to close the collar 1600.

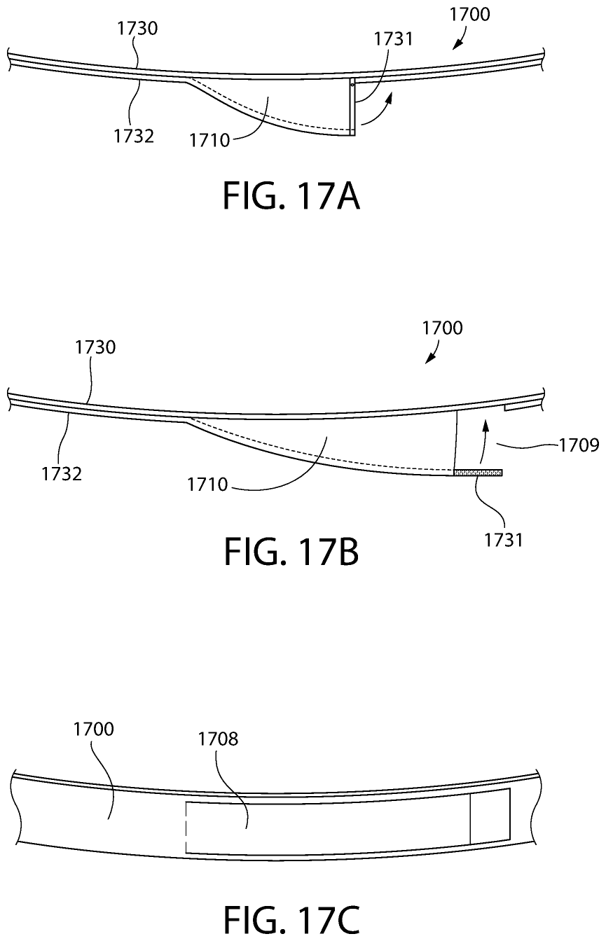

FIGS. 17A, 17B, 17C show an example collar 1700. FIGS. 17A, 17B show top views of collar 1700. As shown on FIG. 17A, collar 1700 may include two or more layers, such as first layer 1730 and second layer 1732 that may create a cavity 1710 (e.g., pocket) for housing electronic device 1708. Electronic device 1708 may be inserted into cavity 1710 of the collar 1700 via one or more openings, such as opening 1709 (FIG. 17B), that may be located at one or more positions. Collar 1700 may include a closing mechanism 1731 that may, for example, close the pocket (FIG. 17A) to retain electronic device 1708 within the cavity 1710 or open the pocket (FIG. 17B) for inserting and/or removing the electronic device 1708. Closing mechanism 1731 may be a portion of collar 1700 and/or an additional appendage to collar 1700. Closing mechanism 1731 may extend from the collar 1700 (e.g., one or more layers of the collar 1700). Closing mechanism 1731 may include an attachment mechanism (such as hook and loop fastener, a button, a loop, snaps, hook and eye closures, elastic (e.g., elastic closures), etc.) that may couple with a portion of the collar 1700 and close the opening 1709 of the collar 1700. FIG. 17C shows a side view of collar 1700 in which electronic device 1708 is inserted within cavity of collar 1700.

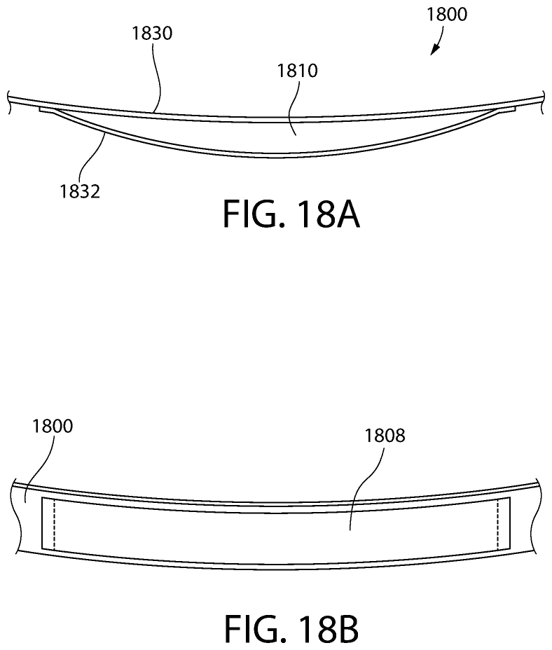

FIGS. 18A, 18B show an example collar 1800. FIG. 18A shows top views of collar 1800. As shown on FIG. 18A, collar 1800 may include two or more layers, such as first layer 1830 and second layer 1832 that may create a cavity 1810 (e.g., pocket) for housing electronic device 1808. One or more of first layer 1830 or second layer 1832 may be formed of elastic or another stretchy material. Electronic device 1808 may be inserted into cavity 1810 of the collar 1800 via one or more openings. For example, cavity 1810 may open (e.g., substantially open) upon the collar 1800 being stretched and close upon the collar 1800 not being stretched. FIG. 18B shows a side view of collar 1800 in which electronic device 1808 is inserted within cavity of collar 1800.

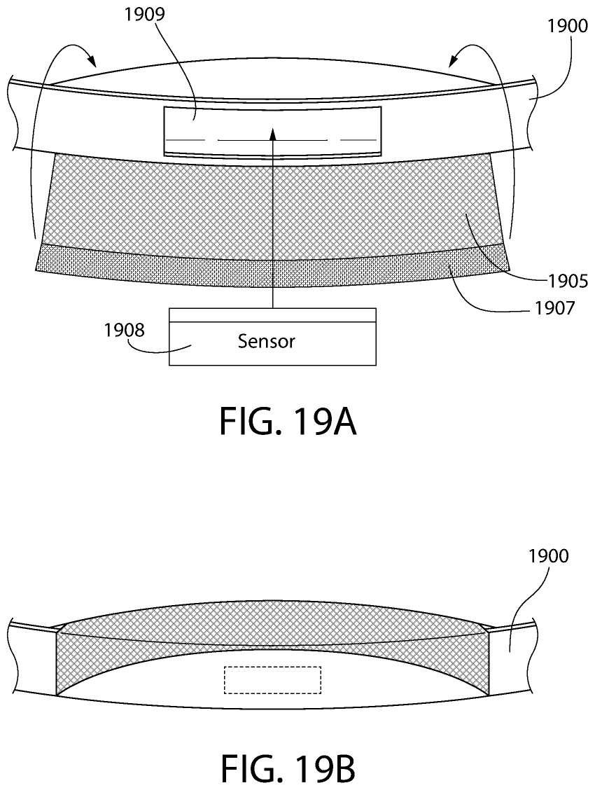

FIGS. 19A, 19B show an example collar 1900 in which the electronic device 1908 may be positioned within collar 1900. Collar 1900 may include a cavity 1909 configured to receive and store electronic device 1908. Cavity 1909 may be formed from one or more layers of collar 1900. Cavity 1909 may be sized and/or shaped to fit a particular electronic device 1900 or generically formed to fit electronic devices of different sizes and shapes. Collar 1900 may include flap 1905 that may wrap around/about collar 1900 (e.g., around cavity 1909 of collar 1900). Flap 1905 may close upon collar 1900 via an attachment mechanism 1907, such as hook and loop fastener, a button, a zipper, a snap, a hook and eye closure, an elastic (e.g., elastic closures), or the like.

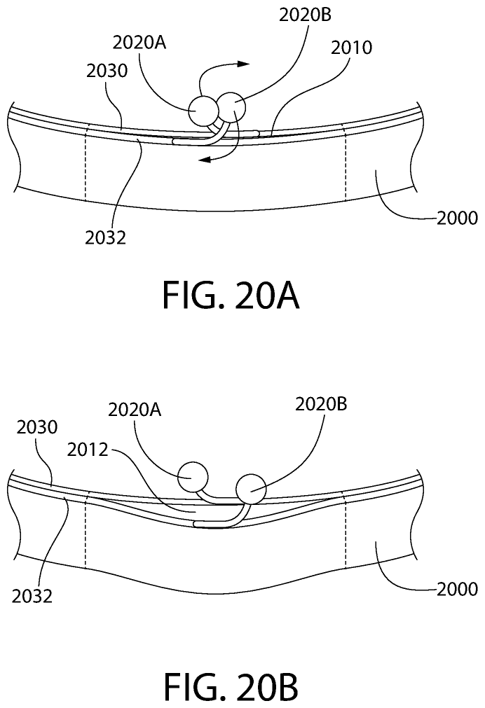

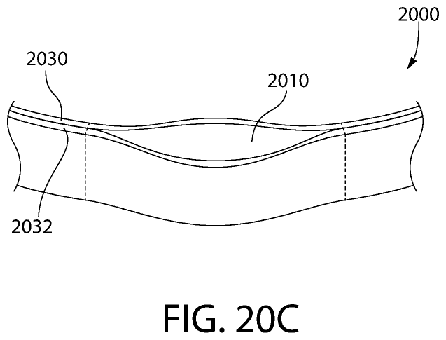

FIGS. 20A, 20B, 20C show an example collar 2000 in which the opening 2010 of collar 2000 is closed via a squeezing of closure mechanisms 2020A, 2020B (collectively 2020). Closure mechanisms 2020A, 2020B may be two or more extending protuberances that may be configured to twist around one another when pressed together. Collar 2000 may include two or more layers, such as first layer 2030 and second layer 2032 that may form cavity 2012. Opening 2010 may provide access to the cavity 2012 (FIG. 20B). Opening 2010 may be closed via the squeezing (e.g., pinching) of the closure mechanism 2020A towards closure mechanism 2020B, or vise-versa. When opening 2010 is closed, opening 2010 may be opened upon a pressing of the closure mechanisms 2020 away from one another. An electronic device (such as electronic device 200) may be inserted into cavity 2012 of collar 2000 via the opening 2010. As described herein, opening 2010 of the cavity may be closed via the closure mechanisms 2020A, 2020B being pressed towards one another. In another example, shown on FIG. 20C, the cavity may be opened and/or closed via a pressure exerted upon one or more of layer 2030 or 2032. An electronic device may be contained within the collar 2000 when opening 2010 of the cavity is closed.

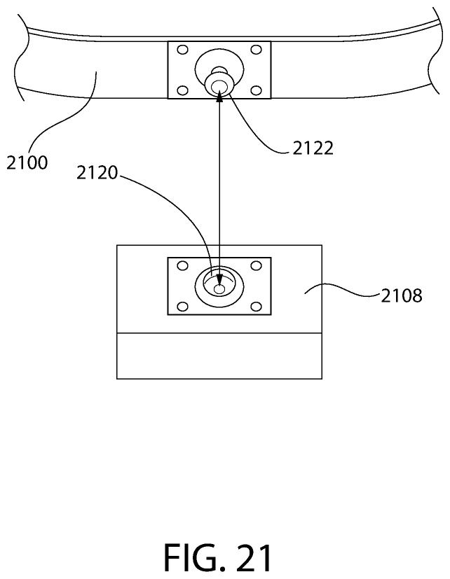

FIG. 21 shows an example collar 2100 and an attachment (e.g., attachment 2108) configured to couple to collar 2100. For example, collar 2100 may have a snap closure, such as male snap closure 2122. Attachment 2108 may have a female snap closure 2120 that may correspond to male snap closure 2122 to couple attachment 2108 and collar 2100. Attachment 2108 may house an electronic device (such as electronic device 200), for example, via a cavity within attachment 2108.

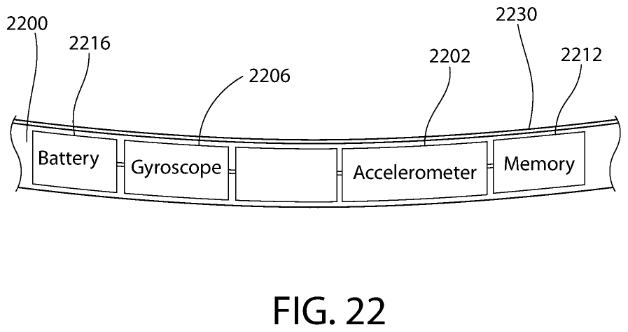

FIG. 22 shows an internal view of an example collar 2200 in which one or more components of electronic device are positioned in a linear fashion. For example, one or more components may be linearly positioned along the longitudinal axis of a collar, such as collar 100. For example, battery 2216, gyroscope 2206, accelerometer 2202, and/or memory 2212 may be positioned adjacent to one another on and/or in collar 2200. Although FIG. 22 shows battery 2216, gyroscope 2206, accelerometer 2202, and/or memory 2212, such layout is not limiting and more or less of the components may be positioned on or in collar 2200. Positioning the components in a linear fashion may reduce the size (e.g., depth, profile) of layer 2230. In examples collar 2200 may be formed of a strong and durable material, such as Kevlar, although such examples are not intended to be limiting.

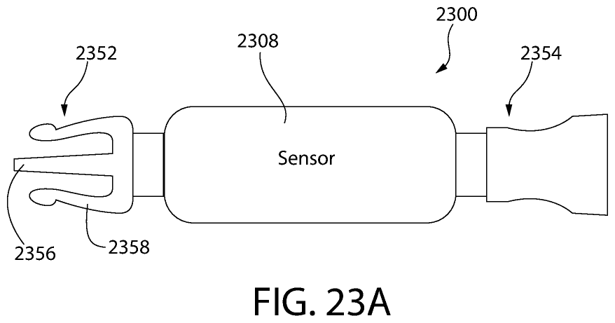

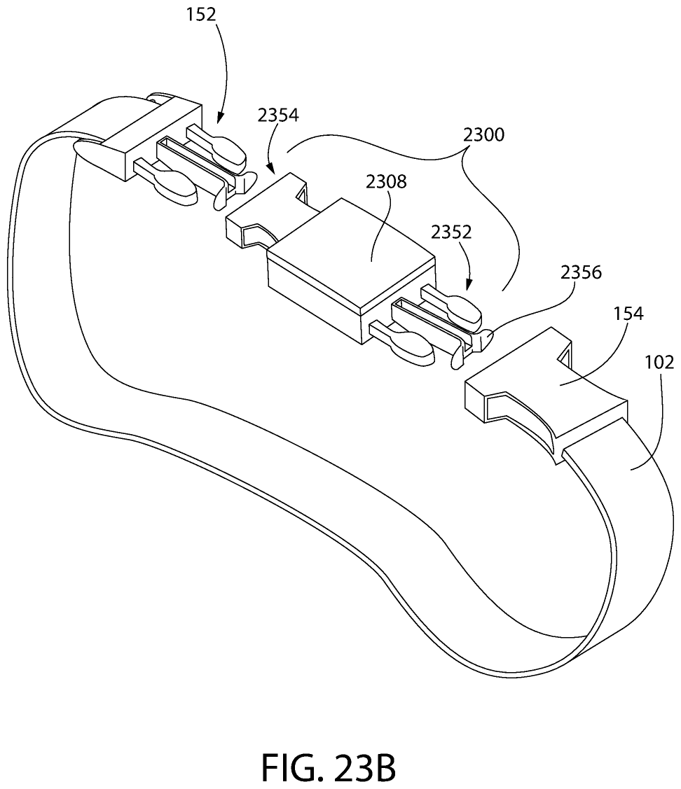

FIGS. 23A, 23B show an example collar attachment 2300. Attachment 2300 may couple to a collar, such as collar 100, via a one or more connecting portions (e.g., male buckle member 2352, female buckle member 2354, etc.). As shown on FIG. 23B, connecting portions of attachment 2300 may include a male buckle member 2352 configured to engage with and/or couple to a female buckle member (e.g., female buckle member 154 of collar 100). For example, male buckle member 2352 of attachment 2300 may have a guide 2356 positioned in the center of two biased anchors 2358 for coupling with female buckle member 154 of collar 100. Connecting portions of attachment 2300 may include a female buckle member 2354 configured to engage with and/or couple to a male buckle member (e.g., male buckle member 152 of collar 100). Male buckle member 2352 of attachment 2300 may have a guide configured to engage with and/or couple to a female buckle member (e.g., female buckle member 154 of collar 100), as described herein. In other examples, connecting portions of attachment 2300 may include one or more loops. Attachment 2300 may be configured to attach to the first and second members of respective terminating ends of the collar via the one or more loops.

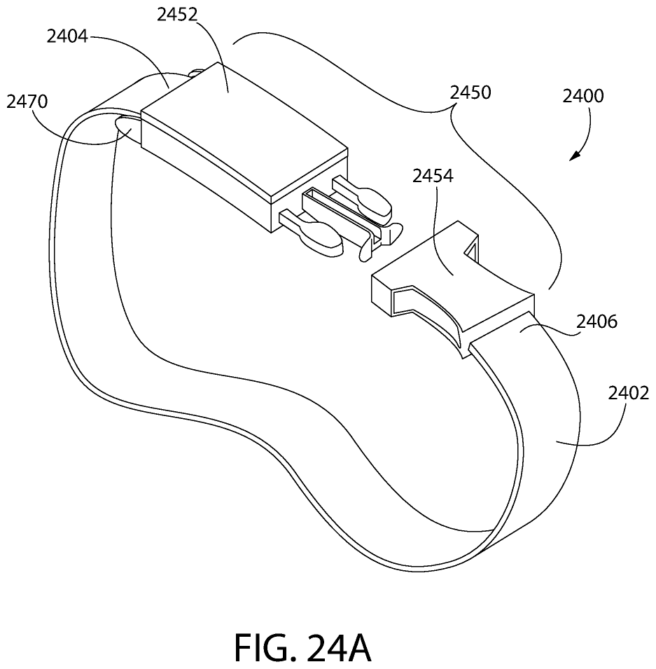

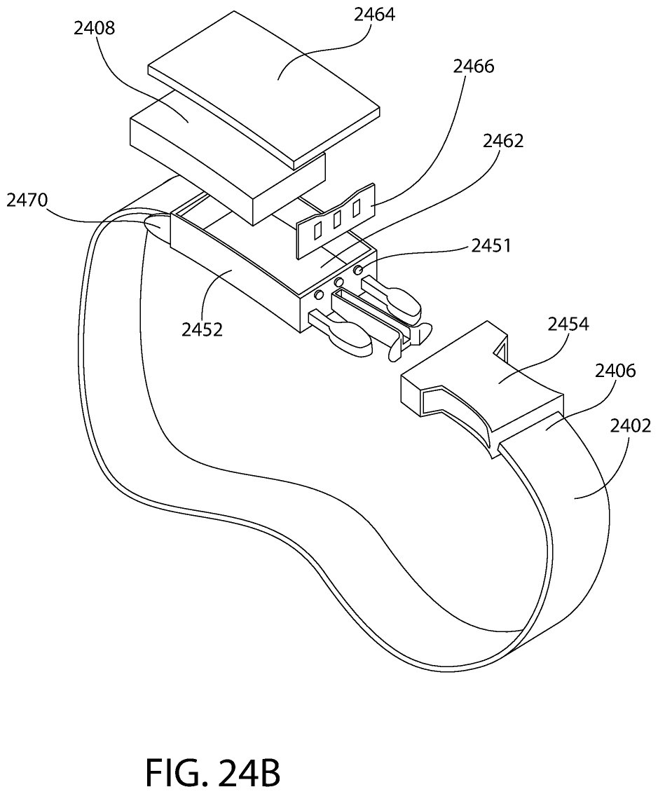

Electronic device (e.g., sensor) 2308 may be housed within attachment 2300. In examples electronic device 2308 may be housed within a housing/casing (e.g., hard casing) of attachment 2300. In an example, attachment 2300 may include a housing similar to the housings shown on FIGS. 23B, 24A, and 24B. For example, attachment 2300 may include a housing similar to male buckle member 2452, shown on FIG. 24B. The housing may include a cover (similar to cover 2464) configured to retain, restrict/permit access to, etc., the sensor (and other components within the housing) within a cavity of housing. Cavity of attachment 2300 may be similar to cavity 2462 (FIG. 24B). Access to the cavity of attachment 2300 may be provided via a removal of a cover. The cover may be used to restrict and/or permit access to the cavity of attachment 2300. In examples the cover may be removed via a sliding of the cover away from the cavity of the electronic device, although in examples access to the cavity (e.g., electronic device within cavity) may be provided via an interface, such as interface 2560 described herein. In other examples electronic device 2308 may be housed within one or more layers of attachment 2300, as described herein. Attachment 2300 may include an electronic device such that connecting attachment to collar 100 may provide functionality of electronic device to collar 100 in a quick, easy, and/or seamless manner. For example, male buckle member 2352 and/or female buckle member 2354 of attachment 2300 may easily and seamlessly attach to respective female and male buckles of collar 100. As collar 100 is configured with female and male buckles, additional materials will not be required to couple attachment 2300 and collar 100.

FIGS. 24A, 24B show an example collar 2400 with a connecting portion 2450. In examples connecting portion 2450 may be similar to connecting portion 150, as described herein. For example, connecting portion 2450 may include a male buckle member 2452 and a female buckle member 2454 for engagement with respective female and male buckle members of collar. In examples, buckle members may be as shown on FIGS. 1A, 1B, 1C, 1D, or may be provided in other buckle configurations. In other examples connection portion 2450 may not be buckles at all and instead may be clips, loops, snaps, and the like. In examples buckle members 2452 and 2454 may be attached to respective terminal ends 2404, 2406 of belt segment 2402, for example, via one or more strap connections 2470. Upon insertion of male member 2452 into female member 2454, anchors 2458 may snap into anchor cavities, thereby retaining collar 2400 on the pet (e.g., on the neck of the pet).

Connecting portion 2450 (e.g., male buckle member and/or female buckle member) may include a cavity, such as cavity 2462 (FIG. 24B). Cavity 2462 may house electronic device 2408. Connecting portion 2450 may include one or more containing portions, such as lid 2464, which may be configured to retain sensor 2408 within cavity 2462. Lid 2464 may engage with a portion (e.g., top portion, side wall portion, etc.) of cavity 2462 and be retained upon cavity. One or more containing portions (e.g., wall portion) may include an interface for accessing the electronic device, as described herein. The interface may be a USB interface, a wireless interface, etc., for accessing the electronic device while the electronic device is attached to the collar. The electronic device may be coupled to the covering portion. In such examples, sliding of the covering portion away from cavity may remove the electronic device from the cavity. In other examples containing portion may be a sliding lid, a snap lid, a hinged lid. In other examples containing portion may not be a lid and instead may be a holding mechanism, such as hook and loop fastener, straps, and the like.

Connecting portion 2450 may include one or more induction pins, such as induction pins 2451. Induction pins 2451 may be made of metal and configured to create (e.g., form) an electric circuit between two or more contacts. Induction pins 2451 may be used to provide power to sensor (e.g., via battery 216) of electronic device 200. For example, when male member 2452 and female member 2454 are pressed together (thereby closing the buckle members), induction pins 2451 may be pressed inward, causing power to be provided to sensor 2408. In other examples, induction pins 2451 may be configured to provide a contact so that battery (such as battery 216) of electronic device (such as electronic device 200) may be charged.

Connecting portion 2450 may include one or more spacers, such as spacer 2466. Spacer 2466 may be positioned at one or more positions, such as adjacent to sensor 2408. As shown on FIG. 24B, spacer 2466 may include one or more contacts that may contact one or more induction pins 2451. Contacts of spacer 2466 may contact induction pins 2451 so that an electric circuit may be formed. In an example, battery (such as battery 216) of electronic device (such as electronic device 200) may be charged via contacts of spacer 2466 contacting with induction pins 2451.

Connecting portion 2450 may be coupled to collar 2400 via one or more configurations. For example, connecting portion 2450 may be coupled to collar via a strap connection, such as strap connection 2470 (FIGS. 24A, 24B) that may receive a segment of collar 2400. Belt segment 2402 of collar may wrap around the strap connection of connection portion 2450 and tighten, thereby coupling the connecting portion 2450 to belt segment 2402 of collar. In another example, connecting portion 2466 may be an attachment to collar 2400, as described herein and shown on FIG. 23B.

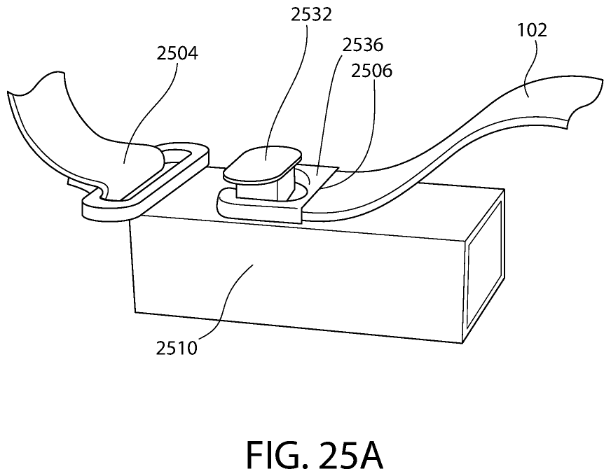

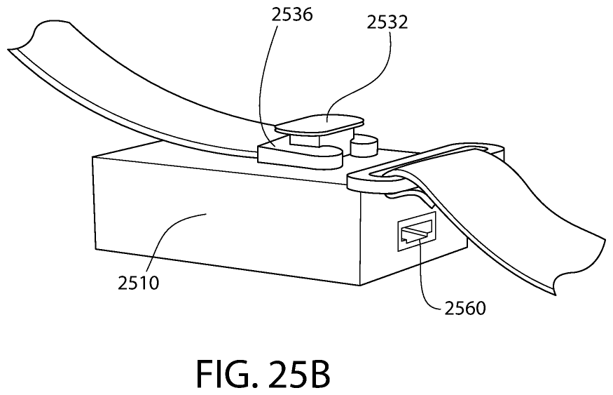

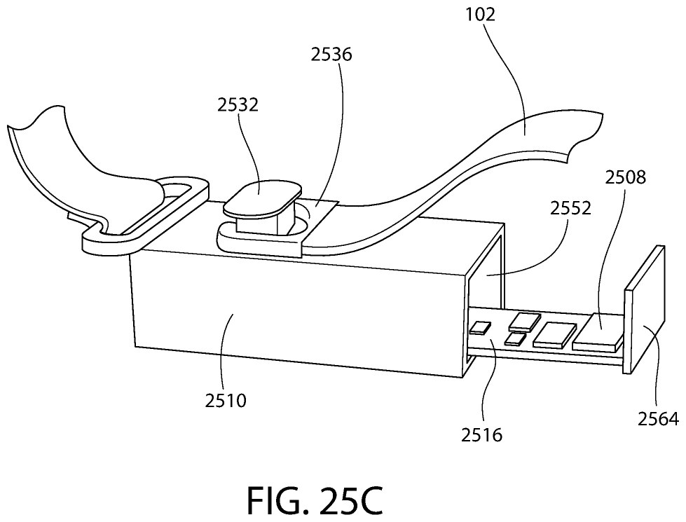

FIGS. 25A, 25B, 25C show an example collar 2500 with a connecting portion. Connecting portion may be similar to connecting portion 175, as described herein. For example, connecting portion may have a male buckle member 2532 and a female buckle member 2536 for engagement with the male buckle member 2532. In an example, buckle members 2532 and 2436 may be attached to respective terminal ends 2504, 2506 of belt segment 102 of a collar.

Connecting portion of collar 2500 may include a housing 2510. Housing may have a cavity, such as cavity 2552 (FIG. 25C). Housing 2510 may include interface 2560 (FIG. 25B) for communicating with one or more devices, such as an electronic device stored within cavity 2552. Interface 2560 may be an interface for charging electronic device (e.g., battery of electronic device), for providing information to electronic device and/or receiving information from electronic device. Interface 2560 may be a physical interface (such as a universal serial bus (USB) storage device) and/or interface 2560 may be a wireless interface. Connecting portion of collar 2500 may include one or more containing portions and spacers, such as containing portions and spacers described herein. Containing portion and spacers may be housed within, coupled to, or in contact with housing 2510. For example, containing portion may be sliding lid that may slide away from housing, although this example is for illustration purposes only and containing portion may be other configurations, such as hinged upon housing 2510, snapped to housing 2510, and the like. Containing portion 2564 may include a substrate (e.g., PCB 2516) for holding electronic device 2508. Further, although portions of the housings (e.g., lid 2464, interface 2560, and/or containing portion 2564) may be described with reference to FIGS. 24 and 25, it should be understood that these descriptions are for illustration purposes only and one or more of the portions may be applied to one or more of the collars and/or attachments, as described herein.

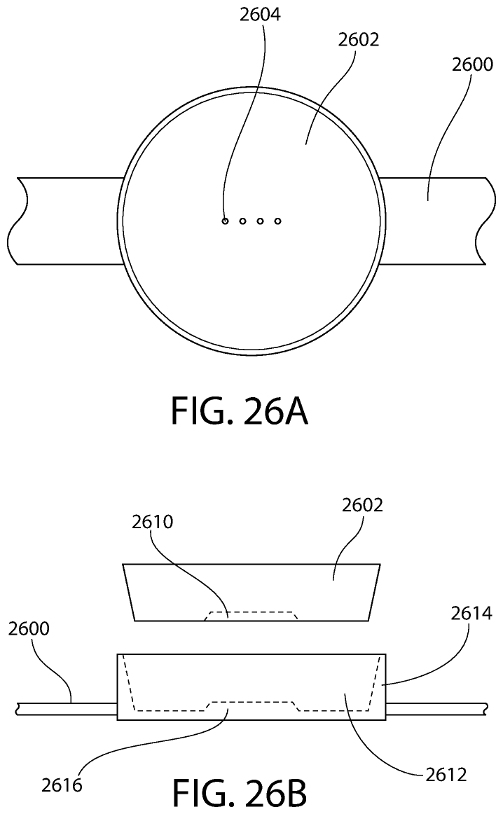

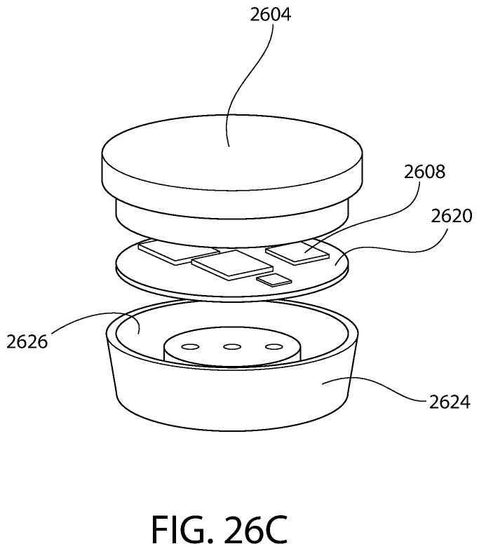

FIGS. 26A, 26B, 26C show an example electronic device 2608 (FIG. 26C) configured to couple to collar 2600. Electronic device 2608 may be electronic device 200, as described herein. Electronic device 2608 may be housed within housing 2602. Housing may include an induction plate, as described herein, which may be used for charging electronic device 2608. Housing 2602 may be formed of a hard material, such as a plastic or other hard material. Housing 2602 may include one or more indicators 2604. Indicators 2604 may be visual indicators (e.g., light indicators, such as an LED light), audio indicators (e.g., sound indicators, such as a speaker), and the like. Indicators 2604 may provide visual information, such as power status information (e.g., indicating whether the electronic device is on/off), battery charge information (e.g., how much charge is remaining on the battery of the electronic device 2602), communication status information (e.g., if electronic device 2602 is capable of wirelessly communicating, or presently communicating), health monitoring information (e.g., if the pet is experiencing a health condition, levels in which the pet is exercising, eating habits of pet, etc.), reminder information (e.g., reminder to provide a medicine or meal for the pet), etc.

Housing 2602 of electronic device 2602 may couple to collar 2600, for example, via a strap of collar 2600. In examples strap of collar 2600 may include a base 2614 for receiving housing 2602 of electronic device 2608, although in other examples the strap of collar 2600 may couple to base 2614 via one or more attachment mechanisms. Base 2614 and/or housing 260 may be formed of a rigid material or may be formed of a soft or semi-rigid material. Base 2614 may include a cavity 2612 for receiving housing 2602 of electronic device 2608. Cavity 2612 may be formed to complement the size and/shape of housing 2602 or may be sized/shaped generically to couple to one or more differently sized and/shaped housings 2602 of electronic devices 2608. For example, base 2614 may be flat (e.g., without walls) such that differently sized and/or shaped housings 2602 may couple to base 2614.

Housing 2602 of electronic device 2608 may be coupled and decoupled from base 2614 via an attachment element. In examples, base may provide an aperture for accessing a coupling/decoupling element 2616 of base 2614. For example, housing 2602 may include a mechanism 2610 (such as pins) that may couple to a corresponding attachment element 2616 of base 2614. A user may use finger manipulation to disengage mechanism 2610 from base 2614. The user may access element 2616 via aperture of base 2614 to disengage mechanism 2610 from base 2614. Housing 2602 of electronic device 2608 may be coupled to base 2614 in one or more of a variety of ways, such as via a magnet, clip, pin, buckle, clasp, snap, hinge, button, or adhesive, etc.

Housing 2602 may include a cavity, such as cavity 2626 (FIG. 26C). Cavity 2626 may house electronic device 2608. Housing 2602 may include one or more containing portions, such as lid 2604, which may be configured to retain sensor 2608 within cavity 2626. Lid 2604 may engage with a portion (e.g., top portion, side wall portion 2624, etc.) of cavity 2626 and be retained upon cavity 2626. For example, lid 2604 may open and close via a twisting action that engages and/or disengages from a threading found on wall portion 2624. In other examples containing portion may be a sliding lid, a snap lid, a hinged lid, a pressure-fitted lid, or may not be a lid. For example, containing portion may be a holding mechanism, such as hook and loop fastener, straps, and the like. Connecting portion 2454 may include an induction plate, such as induction plate 2466 described herein. Induction plate may be used to charge electronic device 2408. Induction plate may be positioned adjacent to electronic device 2608, under electronic device 2608, etc. For example, induction plate may be positioned under electronic device 2608 and on the side closest to the animal. Housing 2602 may include a substrate (e.g., 2620) that may hold electronic device 2608.

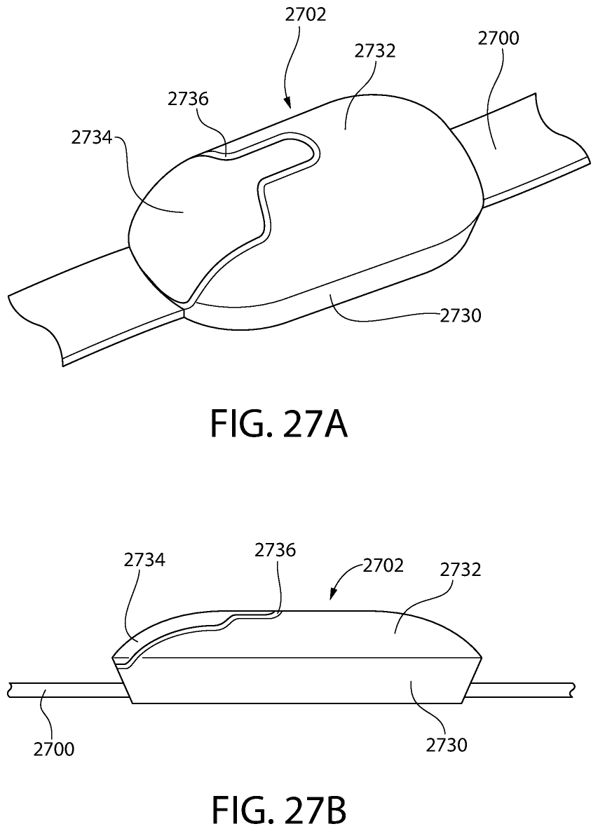

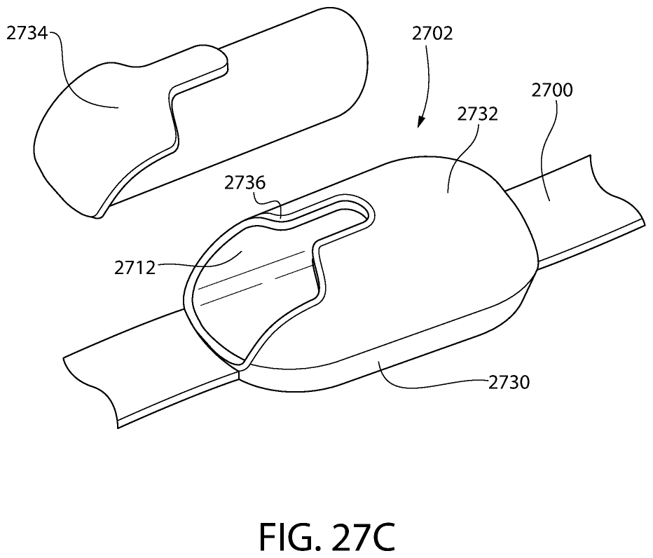

FIGS. 27A, 27B, 27C show an example housing 2702 for an electronic device (such as electronic device 200) that may couple to collar 2700. Housing 2702 of electronic device may couple to collar 2700, for example, via a strap of collar 2700. In examples strap of collar 2700 may include one or more bases for receiving a housing, such as top housing 2734. For example, bases may include a first base 2730 and/or a second base 2732 for receiving housing 2702, although in other examples first base 2730 and second base 2732 may derive a single base. First base 2730, second base 2732, and/or top housing 2734 may be formed of a rigid material or may be formed of a soft or semi-rigid material.

Housing 2702 may include a cavity, such as cavity 2712. Cavity 2712 may house an electronic device (such as electronic device 200). Housing 2712 may include one or more containing portions (such as top portion 2734), which may be configured to retain the electronic device within cavity 2712. Top portion 2734 may engage with a portion (e.g., first base 2730 and/or second base 2732) of cavity 2712 and be retained upon cavity 2712. For example, top portion 2734 may open and close via a sliding action. Top portion 2734 may be a snap lid, a hinged lid, or the like. In other examples, top portion 2734, first base 2730, and/or second base 2732 may include one or more attachment members, such as a clasping member, for attaching (e.g., snugly attaching) top portion 2734 with first base 2730 and/or second base 2732. Top portion 2734 may engage with first base 2730 and/or second base 2732 to provide a water-tight seal. In examples, second base portion 2732 may include seal 2736 (e.g., a pressure seal, gasket, etc.) that may provide a water-tight capability that may prevent water from entering the cavity 2712 upon engagement of top portion 2734 and second base portion 2732

While the inventions have been described with respect to specific examples including presently preferred modes of carrying out the inventions, those skilled in the art will appreciate that there are numerous variations and permutations of the above described systems and techniques. It is to be understood that other embodiments may be utilized and structural and functional modifications may be made without departing from the scope of the present inventions. Thus, the spirit and scope of the inventions should be construed broadly as set forth in the appended claims.

What is claimed is:

1. A wearable animal information apparatus comprising:
a collar configured to be worn around a portion of an animal, the collar comprising an inner surface that faces the portion of the animal during use and an outer surface that faces away from the portion of the animal during use;
a base coupled to the collar;
a housing configured to couple to the base via an attachment element, the housing comprising a plurality of indicators providing visual information relating to at least one of a condition of the animal or an environment surrounding the animal; and
an electronic device comprising a processor configured to receive or transmit information relating to the animal, the electronic device located within the housing;
wherein the base comprises a cavity for receiving the housing and coupling the base to the housing via the attachment element.

2. The apparatus of claim 1, wherein the plurality of indicators provide a visual indication of at least one of a health condition of the animal, exercise history of the animal, or eating habits of the animal.

3. The apparatus of claim 1, wherein the plurality of indicators provide a visual indication of power status information relating to the electronic device or communication status information of the electronic device.

4. The apparatus of claim 1, wherein the plurality of indicators provide a visual indication of environmental conditions surrounding the electronic device.

5. The apparatus of claim 4, wherein the environmental conditions surrounding the electronic device comprise at least one of the weather, precipitation, moisture, or humidity surrounding the electronic device.

6. The apparatus of claim 1, wherein the attachment element comprises at least one of a magnet, clip, pin, buckle, clasp, snap, hinge, button, or adhesive to detachably couple the housing of the electronic device to the base located on the outer surface of the collar body.

7. The apparatus of claim 1, wherein:
the attachment element comprises a pin to detachably couple the housing to the base located on the outer surface of the collar body; and
the housing of the electronic device comprises an aperture for inserting a finger to engage the pin with the base.

8. The apparatus of claim 1, wherein the electronic device comprises a global positioning system (GPS) component, the information relating to the animal comprising location information of the animal derived from the GPS of the electronic device.

9. The apparatus of claim 1, wherein the information relating to the animal comprises at least one of an identity of the animal, a home address of the animal, information relating to the owner of the animal, or medical information of the animal.

10. A wearable animal information apparatus comprising:
a collar configured to be worn around a portion of an animal, the collar comprising an inner surface that faces the portion of the animal during use and an outer surface that faces away from the portion of the animal during use;
a housing comprising:
a base portion coupled to the collar;
a cavity;
a top housing portion configured to engage with the base portion to enclose the cavity; and
an electronic device comprising a processor configured to receive or transmit information relating to the animal, the electronic device located within the cavity of the housing and retained by the top housing portion.

11. The apparatus of claim 10, wherein the top housing portion is configured to slideably engage with the base portion of the collar to enclose the cavity housing the electronic device.

12. The apparatus of claim 11, wherein the housing comprises a seal, the top housing portion of the electronic device slideably engaging with the seal to form a water tight seal enclosing the cavity housing the electronic device.

13. The apparatus of claim 12, wherein the seal is positioned upon the base portion of the wearable collar.

14. The apparatus of claim 10, wherein the base portion comprises a substantially flat first base portion coincident with the collar body and an extending second base portion that extends from the flat first base portion,
wherein the top housing portion of the electronic device slideably engages with the flat first base portion and the extending second base portion of the base portion to enclose the electronic device.

15. The apparatus of claim 10, wherein the electronic device comprises a global positioning system (GPS) component, the information relating to the animal comprising location information of the animal derived from the GPS of the electronic device.

16. The apparatus of claim 10, wherein the information relating to the animal comprises at least one of an identity of the animal, a home address of the animal, information relating to the owner of the animal, or medical information of the animal.

17. A wearable animal information system comprising:
a collar configured to be worn around a portion of an animal, the collar comprising an inner surface that faces the portion of the animal during use and an outer surface that faces away from the portion of the animal during use;
a housing comprising:
a base portion coupled to the collar, the base portion comprising a seal;
a cavity; and
a top housing portion configured to engage with the seal of the base portion to form a water tight seal enclosing the cavity for the electronic device; and
an electronic device comprising a processor configured to receive or transmit information relating to the animal, the electronic device located within the cavity of the housing and retained by the top housing portion.

18. The wearable animal information system of claim 17, wherein the base portion comprises a first base portion and a second base portion,
wherein the top housing portion slideably engages with at least one of the first base portion or the second base portion.

19. The wearable animal information system of claim 17, wherein the base portion comprises a first base portion and a second base portion,
wherein the top housing portion engages with at least one of the first base portion or the second base portion via a snapping element or a hinge.

20. The wearable animal information system of claim 17, wherein the information relating to the animal comprises at least one of an identity of the animal, a home address of the animal, information relating to the owner of the animal, or medical information of the animal.
